(19) United States
(12) Patent Application Publication
(10) Pub. No.: US 2022/0172309 A1
(43) Pub. Date: Jun. 2, 2022

(54) ADAPTIVE MODEL FOR PROVIDING PROPERTY LISTING RECOMMENDATIONS

(71) Applicant: Land On Earth, Inc., San Antonio, TX (US)

(72) Inventors: Jesus Mario Corona Pompa, San Antonio, TX (US); German Jorge Rodriguez-Davalos, San Antonio, TX (US)

(21) Appl. No.: 17/602,732

(22) PCT Filed: Apr. 10, 2020
(86) PCT No.: PCT/US2020/027833

§ 371 Date: Oct. 8, 2021

Related U.S. Application Data
(60) Provisional application No. 62/832,174, filed on Apr. 10, 2019.

(51) Int. Cl. G06Q 50/16; G06Q 30/06

(52) U.S. Cl. CPC G06Q 50/16; G06Q 30/0631

(57) ABSTRACT

The subject disclosure relates to solutions for matching real-property listings with users (consumers) based on user demographic and preference data. In some aspects, a matching system of the disclosed technology utilizes a machine-learning model for identifying and performing relevance ranking of real-property listings based on the demographic and preference information. In some aspects, a process of the technology includes steps for receiving demographic data associated with a user, receiving preference data associated with the user, receiving listing data comprising property listings associated with one or more parcels of real property, and determining a matching relevance for one or more of the property listings based on the demographic data. Systems and machine-readable media are also provided.

### CROSS-REFERENCE TO RELATED APPLICATIONS

This application claims the benefit of U.S. Application No. 62/832,174, filed Apr. 10, 2019, entitled “ADAPTIVE MODEL FOR PROVIDING PROPERTY LISTING RECOMMENDATIONS”, which is incorporated by reference in its entirety.

### BACKGROUND

### 1. Technical Field

The present disclosure generally relates to a platform for making property recommendations and in particular, to an adaptive computer model configured for automatically identifying real property listings based on user preference information.

### 2. Introduction

Conventional real estate searching platforms provide basic search parameters, such as price and size, which are used to return listing results. However, conventional searching platforms do not provide the ability to make targeted listing recommendations based on changing user preference information and/or based on changes to listing parameters, such as resident demographics or business information.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a conceptual block diagram of a property matching system, according to some aspects of the disclosed technology.

FIG. 2 illustrates examples of a graphical user interface (GUI) that can be implemented to facilitate user-interaction with a matching system of the disclosed technology.

FIGS. 3A and 3B illustrate diagrams of container architectures that can be used to implement a matching system of the disclosed technology.

FIGS. 4A and 4B illustrate diagrams of container architectures that can be used to implement a matching system of the disclosed technology.

FIG. 5A-5E illustrate block diagrams and example graphical interfaces that can be used to implement an example property matching process, according to some aspects of the disclosed technology.

FIG. 6A-6C conceptually illustrate a block diagram of a matching engine, according to some aspects of the disclosed technology.

FIG. 7 illustrates an example of a processor-based system that can be configured to implement some aspects of the disclosed technology.

FIGS. 8A-8D illustrate an example block diagram of a real-property matching platform, according to some aspects of the disclosed technology.

FIGS. 9A-9G illustrate examples of a graphical user interface (GUI) that can enable a user to interact with a property matching platform of the disclosed technology.

FIGS. 10A-10B illustrate examples of a graphical user interface (GUI) that can enable a user to interact with a property matching platform of the disclosed technology.

FIG. 11 illustrates an example of a graphical user interface (GUI) that can enable a user to interact with a property matching platform of the disclosed technology.

FIG. 12 illustrates an example of a graphical user interface (GUI) that can enable a user to interact with a property matching platform of the disclosed technology.

FIG. 13 illustrates a conceptual block diagram of a machine-learning implementation of a matching system of the disclosed technology.

FIG. 14 illustrates steps of an example process for performing matching real-property listings with a user, according to some aspects of the disclosed technology.

### DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the disclosed technology address limitations of conventional real proper search systems, by providing search results and listing recommendations that are returned based on highly-granular customer (user) preference and listing information. As used herein, customer preference information can encompass any customer/user data or correlated signals that can be used to infer customer preferences with respect to the consumption of real estate (real property) listings. By way of non-limiting example, preference information can include demographic data, such as: age, sex, location, rental/ownership status, marital status, income level, and/or occupation, etc. Preference information may also include consumer preference data such as restaurant preferences, multimedia consumption data, etc. Additionally, listing information can include any data relating to real property listings and/or data pertaining to property owners and/or renters and other data discussed below.

In some aspects, the disclosed real property listing platform can receive various types of preference and listing information, and use the information to make targeted property recommendations, in some cases, that include information and links to facilitate the user's ability to rent and/or buy property.

In some aspects, property recommendations are made using a machine learning (ML) model that can be trained/tuned based on user selections and/or other criteria. Although various types of machine learning models may be deployed to identify matchings between users and property listings, in some aspects, one or more ML based classification algorithms can be used. Such classifiers can include, but are not limited to: a Multinomial Naive Bayes classifier, a Bernoulli Naive Bayes classifier, a Perceptron classifier, a Stochastic Gradient Descent (SGD) Classifier, and/or a Passive Aggressive Classifier, or the like. Additionally, the ML models can be configured to perform various types of regression, in some cases, using one or more various regression algorithms, including but not limited to: a Stochastic Gradient Descent Regressor, and/or a Passive Aggressive Regressor, etc.

In practice, user preference data is ingested into a listing system and exposed to a matching algorithm (e.g., a ML based classifier) that is configured to return listings to the user in an order of relevance. In some aspects, portions of the user preference data may be automatically received and processed by the listing system, and may include at least some data that is volunteered and provided by the user, in some cases, as part of a manual configuration process.

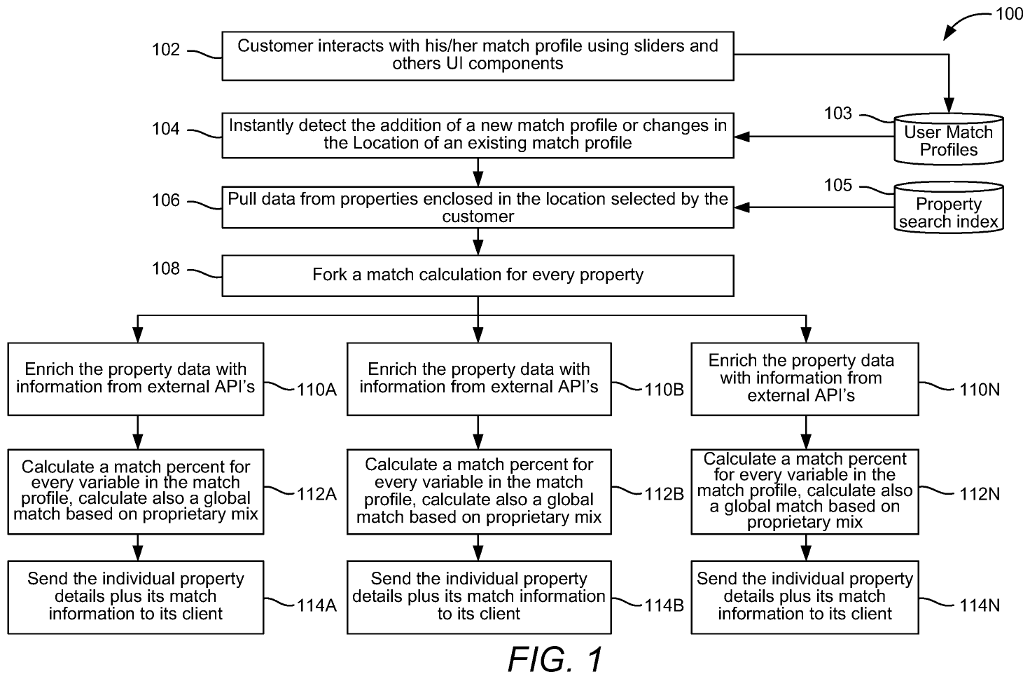

FIG. 1, illustrates a flow diagram of an example process 100 for implementing a property match algorithm and returning details to a customer regarding matched property listings. It is understood that example process 100 illustrates an example of one possible implementation of a matching algorithm of the disclosed technology, and that, some examples, some steps may be excluded.

Process 100 begins with step 102 in which the customer interacts with his/her match profile using sliders and other User Interface (UI) components. Customer interaction may occur through engagement with the mobile application, in some cases, that is installed on a mobile electronic device, such as a smart phone or tablet device. In other approaches, customer interaction may occur through engagement with a web interface or software provided on a personal computer.

Irrespective of the implemented software interface, customer interactions are communicated to a database of user match profiles, user match profile database 103. In some examples, user match profile database 103 can be hosted on a remote server/system and/or may consist of a distributed database hosted across a multitude of network connected computing devices, in some cases, in a computing cluster or cloud computing environment. In some aspects, customer interactions can provide indications of customer preferences relating to a search for real property listings. By way of example, the UI through which the customer interacts may provide options for specifying a variety of parameters associated with real property listings, including, but not limited to: price, size, geographic location, property type, e.g., house, condominium, apartment, townhouse, mobile home, etc. Using by ingesting customer preference information, user match profile database 103 can be updated to reflect profiles based on individual customer preferences.

Subsequently, at step 104, changes to existing match profiles, and new match profiles are detected. Profile changes may reflect changes to a customer's property search preferences, in some cases, indicating changes in a customer's preferred property location, size, price, etc. A search can be performed based on the provided customer preferences and updated user profile information supplied by database 103 (step 106). In particular, user/customer profiles may be used to match one or more parameters relating to property listings that are stored in property search index database 105. In some aspects, matching between the updated user profile and property search index 105 may be constrained by one or more specific parameters, such as a geographic location specified by the customer. In other aspects, customer profiles may be compared against all (or a subset) of the listings contained in property search index 105.

Subsequently, a match calculation for every property is forked, as described with respect to step 110N-114N (step 108). In other words, each property may have any number of different match calculations performed using different external information sources, different algorithms, and/or different factors. In some cases, for each property listing, property data is enriched with information from external data sources, and may be pooled using an interface such as an Application Programming Interface (API). As used herein, enrichment pertains to adding additional related information about the property from external information sources. The additional related information would be useful in matching that property based on different customer preferences.

Different APIs may be used for different external information sources, such as YELP (step 110_{A-C}). Next, property matching is performed and a match percentage is calculated for each variable in the match profile (step 112_{A-C}). As discussed above, one or more machine learning techniques may be implemented to improve the matching. In some aspects, matching may be performed by performing a statistical comparison between customer preferences contained in customer profile information, and real property listing data. In some instances, the match percentage calculation also includes the calculation comprising a global match based on a proprietary mix of profile variables and property characteristics. In some examples, certain parameters (such as price) may be weighted more heavily than other parameters (such as size) for a particular customer or for a particular search. In some examples, relative weightings for parameters used to match property listings can be performed differently on a customer-by-customer basis, or in a search-by search-basis.

After a match percentage calculation is completed for a particular user, with respect to each return property listing, individual property details are provided to the client for each respective listing. Such property details may be provided via user interface (UI), such as the UI discussed above with respect to step 102. In some examples, property details may be returned to the customer via other communication channels, such as email, SMS message, notifications, and/or the like.

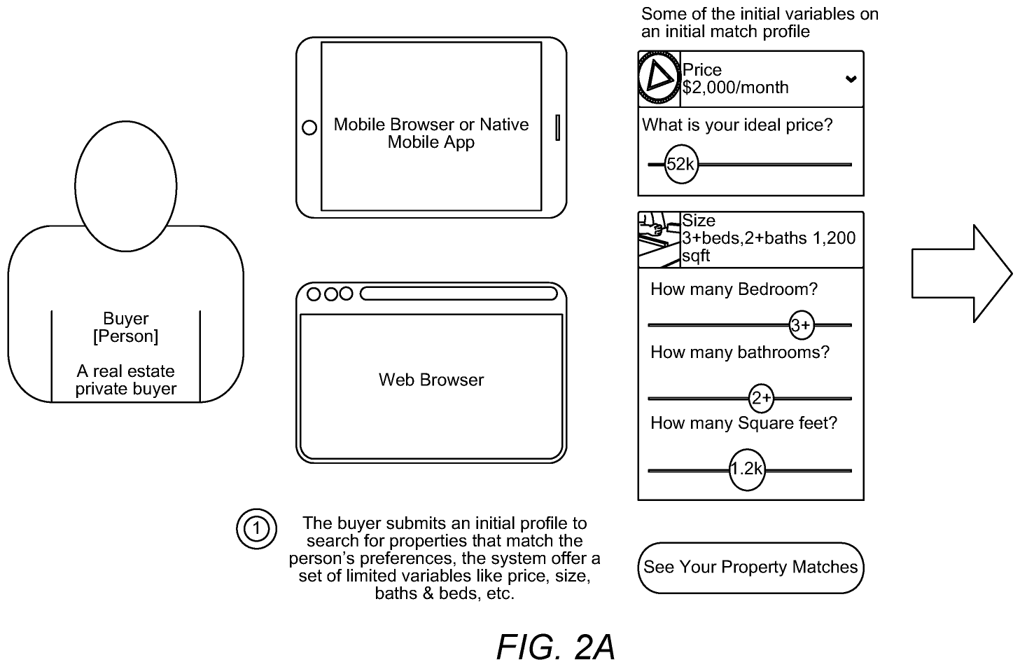

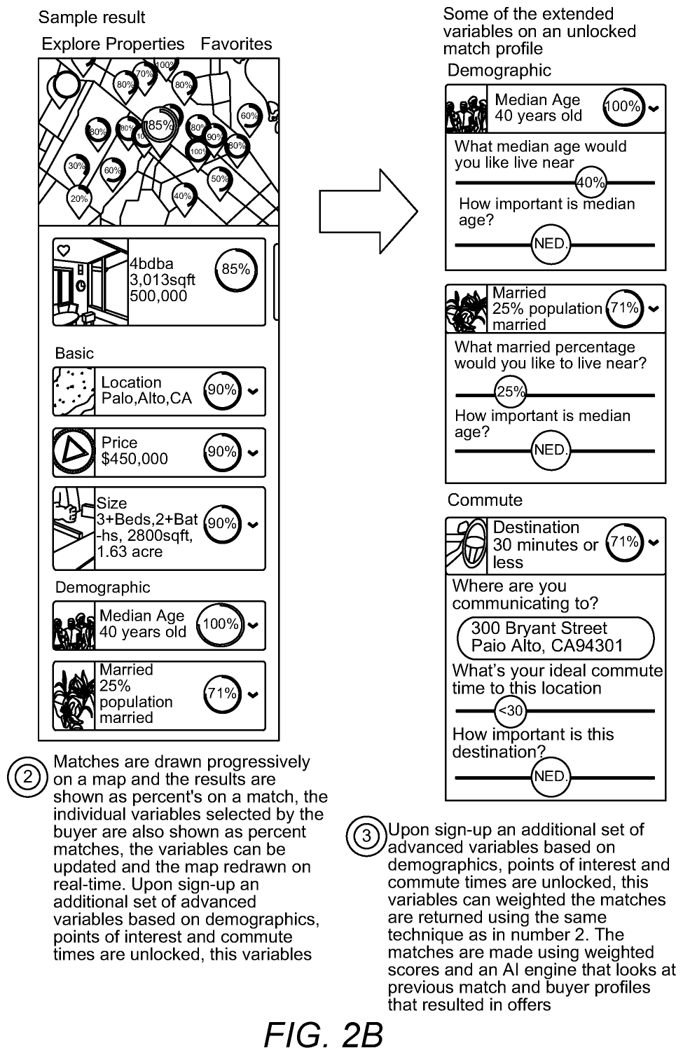

FIG. 2, illustrates a flow of an example process in which a user/buyer requests customized property listing suggestions from a listing system. As illustrated, certain user preference data can be provided to the listing system via a computer interface, such as a web browser (e.g., a mobile web browser), and/or such as via an application that is provided on a mobile platform, such as the operating system (OS) of a mobile device, e.g., a smartphone, or tablet computing device.

As indicated by FIG. 2, user preference information can be solicited from the user/buyer via an interface that is provided by the listing system and/or by a listing application, such as a mobile app, e.g., a UI as discussed above with respect to FIG. 1. Example prompts used to elicit user preference information can request inputs relating to listing price, size, or property layout specifics, such room count (e.g., bedrooms and/or bathrooms), and/or a walkability score, etc.

Depending on implementation, matched property listings can be displayed to the user in a manner that provides contextual information regarding nearby properties in the same geographic region. In some examples, other information associated with the returned listings can be provided, such as demographic information for residents (owners and/or renters) in adjacent listings.

In some cases, if the user is interested in finding property within an area where other residents share the same age or marital status, the user can provide such preferences within an interface (e.g., a slider) and also provide a level of importance for that preference. In some examples, the property listings can be based on demographic information of the residents (e.g., owners or renters) in adjacent properties.

In some aspects, the user may also be able to provide additional preferences such as commute-related information and specify a level of importance in finding property near a work location. In some examples, the user can provide a destination regarding where they work and an ideal commute time. By using traffic information on the internet, information about how far the user may need to commute from the property to their work could be provided. In some aspects, the interface may filter properties such that only properties that are within a preferred commute time may be shown for selection. In some examples, each property can be shown and can be distinguished (with, in some cases, colors or icons) to identify properties that fall within the preferred commute time.

In connection with FIG. 2, the real property matching system may integrate with, or include, a variety of Application Programming Interfaces (APIs) that are configured to allow access to various types of user preference information. Such additional information may include information about nearby restaurant or business review systems (e.g., YELP), or geolocation services (e.g., Google Maps), and/or may incorporate information from other APIs through which information about users/buyers and/or demographic information for renters/owners in a surrounding area can be received.

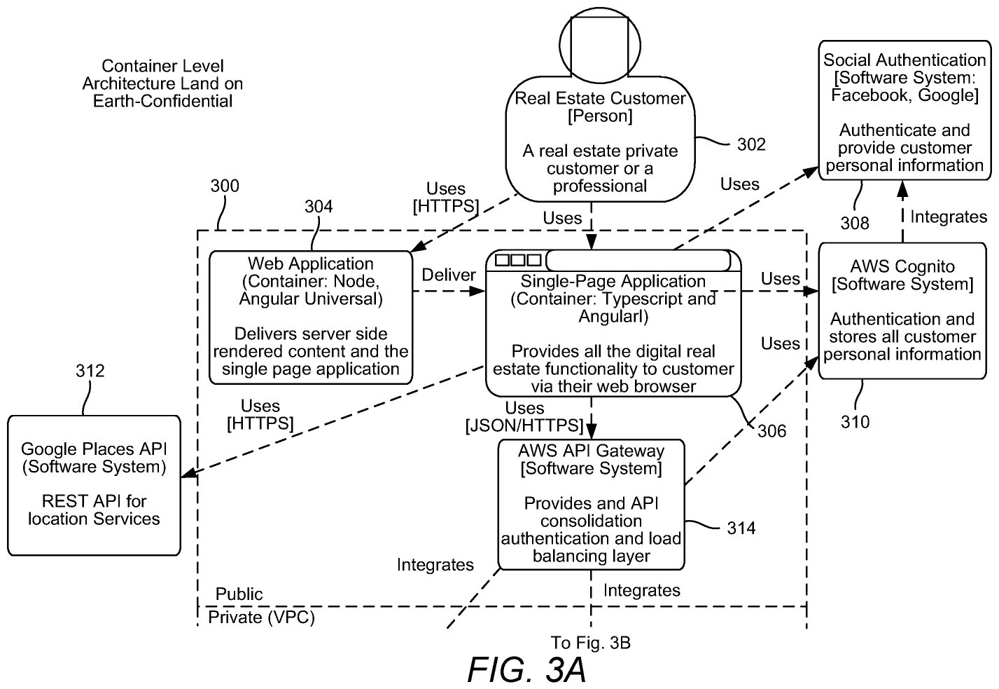

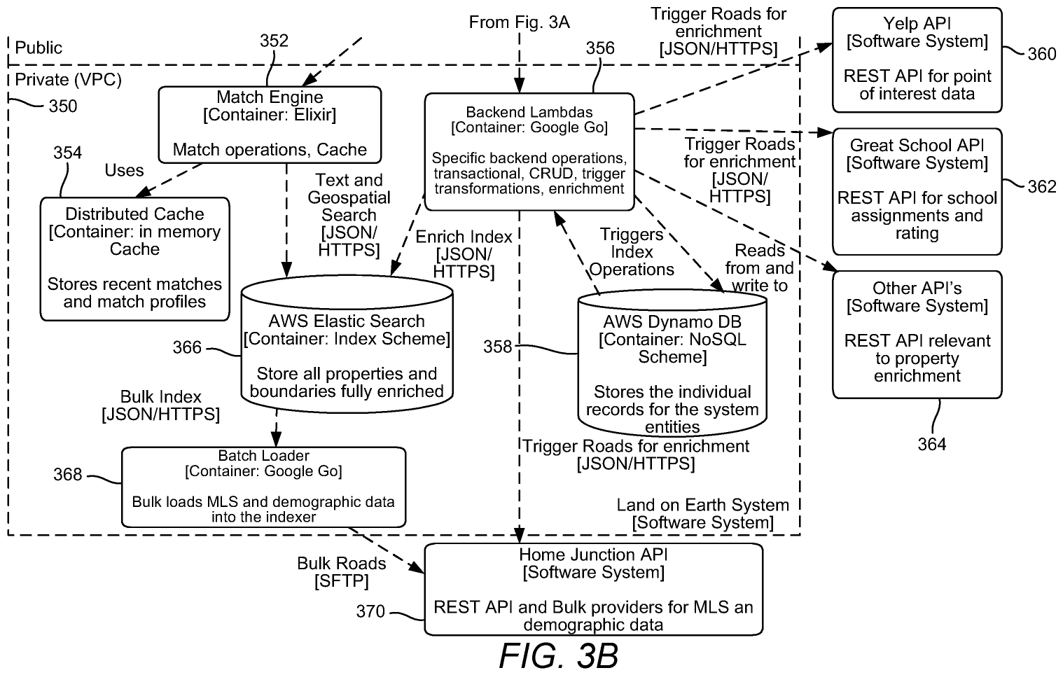

FIG. 3A and FIG. 3B, illustrate an example container level architecture of a real property listing system of the disclosed technology. Specifically, the example container level architecture is broken into two parts, one that interfaces with the public portion (illustrated in FIG. 3A) 300 with another part that corresponds to internal (or private) portions 350 that perform the data gathering and processing associated with the property matching (illustrated in FIG. 3B). Although the example architecture of FIG. 3A and FIG. 3B is illustrated as using containers, in some examples, other virtualized network functions, such as virtual machines (VMs), may be used. Additionally, it is understood that the disclosed real property matching system may be implemented using multiple cloud platforms, such as one or more cloud platforms provided by Amazon Web Services (AWS), or by Google, e.g., Google Cloud, etc.

With respect to FIG. 3A, the example container level architecture has a number of elements associated with the public portion 300 of the real property matching system that users (or customer) 302 can interact with and access in order to obtain property recommendations. The user 302 can access the real property matching system via a web application 304. The web application 304 can be displayed on various different computing devices that have access to the Internet and deliver server side rendered content for the customer 302 to view (e.g., property suggestions). In some examples, any mobile device, laptop, or desktop capable of connecting to the Internet to download and execute the web application 304 may be compatible with the real property matching system.

In some aspects, the web application 304 can provide to the customer 302 a single-page application 306 that provides all the digital real estate functionality to the customer 306. This single-page application 306 will be used, in some cases, to collect personal information about the user but also provide the property suggestions based on the user preferences that can be viewed via the user computing device.

The single-page application 306 can also perform authentication about the customer 302. In some examples, the use of different software systems related to user accounts on social media (e.g., Facebook) or other online services (e.g., Google) can be used to authenticate that the customer 302 is who he/she says they are. Such authentication can utilize username and password combinations in order for the customer 302 to sign into the property matching system. Once the customer syncs their account with the property matching system, customer information found on those accounts can be provided back to the property matching system. In some examples, this customer information can be used to improve information about the customer 302 that may be useful for suggesting properties and also be used in connection with property suggestions for other customers in a similar or identical situation as customer 302 that purchases or rents property.

In some aspects, the single-page application 306 can also be used in connection with another software system for the purposes of authenticating and storing customer personal information 310. This software system 310 may be associated with an account specific for the customer 302 that may be used to store all information collected about the customer 302. Much like accounts on social media or other online services, customers 302 can be required to identify and authenticate who they are via username/password/two-way authentication before being able to access their information in connection with the property matching system.

In some aspects, the single page application 306 can also utilize location-based software systems 312. The location-based software system 312, in some examples, Google Places API, provides the single page application 306 with location-based services.

Through the single-page application 306, the property matching system uses a software system gateway 314 to connect the public portion (that interfaces with customers 302) with the internal (or private) portion of the property matching system that performs the property recommendations. The software system gateway 314, in connecting the public and private portions of the property matching system, provides authentication and load balancing. The authentication may facilitate the internal/private portion associated the connection of the property matching system to an appropriate public portion tied to the customer 302. In some examples, load balancing controls the work-related distribution between the various elements illustrated in FIG. 3B, and may be used to provide properties based on customer preference.

With respect to FIG. 3B, the figure illustrates the elements associated with the private portion 350 of the property matching system. The private portion 350 may correspond to elements internal to the property matching system that carry out the underlying filtering and matching of property based on customer preferences. The information that is obtained via the private portion 350 may be provided to and displayed using the web application illustrated in FIG. 3A. Because each customer may have different customer preferences, the property matching may perform specific matching for each customer based on respective information and preferences.

In some aspects, match engine 352 performs the matching between all the possible property listing and the user preferences. By using the information obtained from the search performed by the elastic search 366 (described below), the match engine 352 can use information about the customer preferences and identify potential property listings that may be of interest to the customer. In some examples, the customer preferences may be stored within the cache.

A distributed cache 354 is used to temporarily store the properties that have been matched with the particular customer. These matched properties can be stored within the distributed cache 354 so that the properties can subsequently be provided to the customer upon request. The matched properties that are stored within the distributed cache 354 may remain stored within the cache until either the customer preferences have changed or until after a pre-determined period of time in which the cache may be emptied for use by other customers.

In some aspects, backend operations 356 are performed on one or more databases. In some examples, the backend operations 356 facilitate in the transactional operations within the private portion 350 of the property matching portion. In some examples, transactional operations may include transformation and enrichment of additional information that can be used in the property matching. The additional information can be used to identify points of interest or additional details that could be used to enrich the property listings so that the matches can be better made based on customer preference.

In some aspects, the dynamo database 358 is used to store entries for each property list that the property matching system currently has available. These listings can be obtained from various different sources (e.g., MLS) and can be updated at various time intervals. The information stored may pertain only to the property itself. In some examples, if the user is interested in other details about the property that are not property-specific, these entries may need to be further enriched in order to be relevant based on the customer preferences related to non property-specific details. In some examples, different APIs 360, 362, and 364 can be used to identify different types of information that may be relevant to the property of interest depending on the customer preference but are not specific to the property itself. These types of information can be used to enrich the entries stored within the database 358 and subsequently stored in the elastic search database 366 (described below).

In some aspects, YELP API (or any other related location-based software system) 360 could identify points of interest in connection with a property. In some examples, if a customer indicates that the customer would like to live near certain areas, the YELP API 360 may be used to locate those points of interest. In some examples, YELP API 360 may provide the points of interest that are nearby certain properties without the customer needing to request for such information.

In some aspects, School API 362 may include specific information about schools and school districts. In some examples, if the customer is interested in obtaining information about the quality of schools and/or school districts in an area (e.g., the customer wants to live near a high school with a particular rating threshold), the School API 362 may have the related information and either filter the properties in order to show properties that satisfy school-related preferences or provide such information about the schools in connection to the corresponding properties. In some aspects, API 364 is a placeholder for one or more different types of software systems that may be included. In some examples, more, less, and different types of APIs may be included with the property matching system than what is currently being illustrated in FIG. 3B.

In some aspects, elastic search database 366 is used to store property listings that the property matching system has. In some examples, the database 366 may store the boundaries of various properties and markets so that customers can search specific markets or locations. In some examples, the information is enriched so it contains the additional information. In some examples, the additional information enriched from API 364 and School API 362 includes customer preferences that take into account various points of interest or quality of nearby schools to factor in what properties are matched and shown to the customer.

In some aspects, batch loader 368 provides the private portion 350 of the property matching system a way to obtain the property-related information from the various different sources (e.g., MLS). In some examples, the batch loader 368 can also provide the property matching system demographic-based information about each of the residents of those properties. This demographic-based information can initially be stored in the elastic search database 366 and moved to the dynamo database 358 so that the information be further enriched.

In some aspects, the home junction API 370 is separate from the property matching system and is associated with the various sources that contain the property listings that the property matching system would be interested in. The home junction API 370 may, in some cases, be associated with a source (e.g., installed on respective computing devices or servers) and allow the property matching system to obtain the property listing data. In some examples, the retrieval of the property data from these sources can be performed at various times or on demand (e.g., whenever a customer provides a request for information that is not found in the databases 358 or 366).

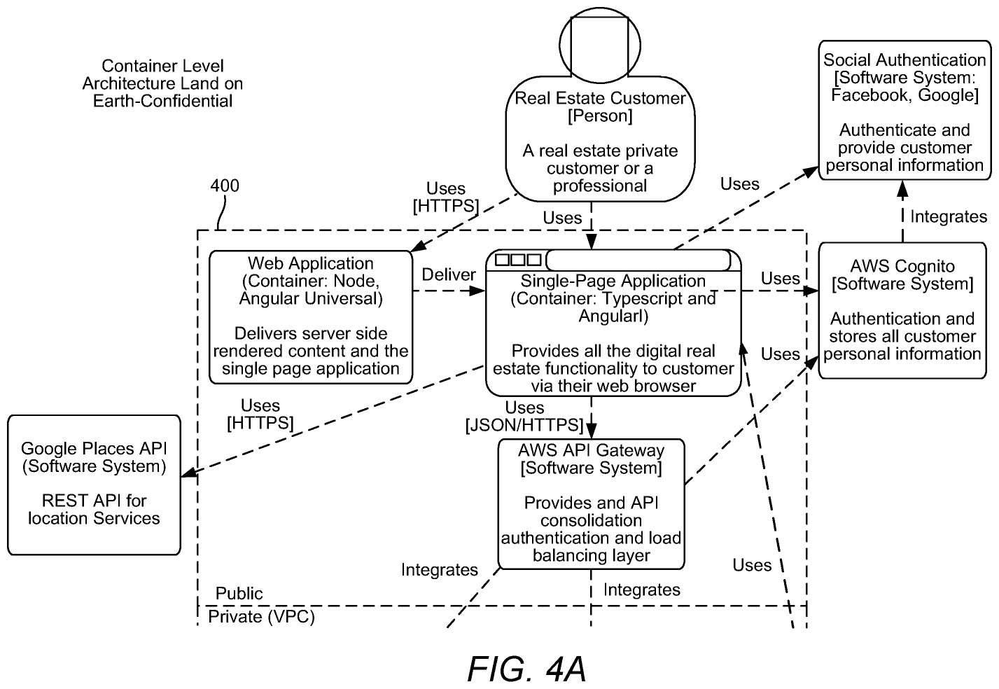

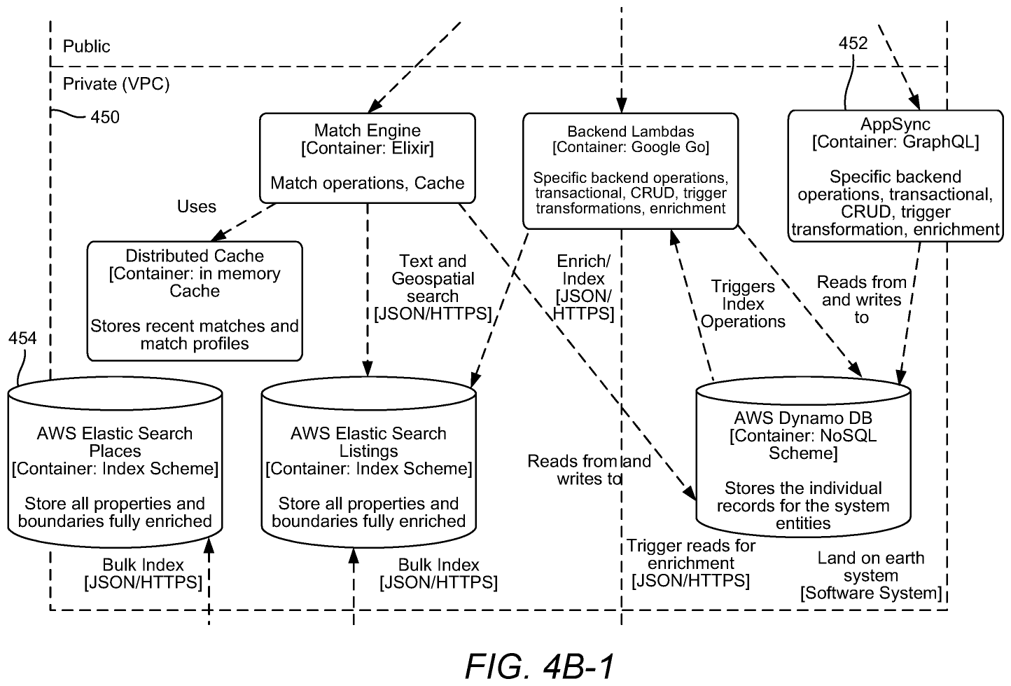

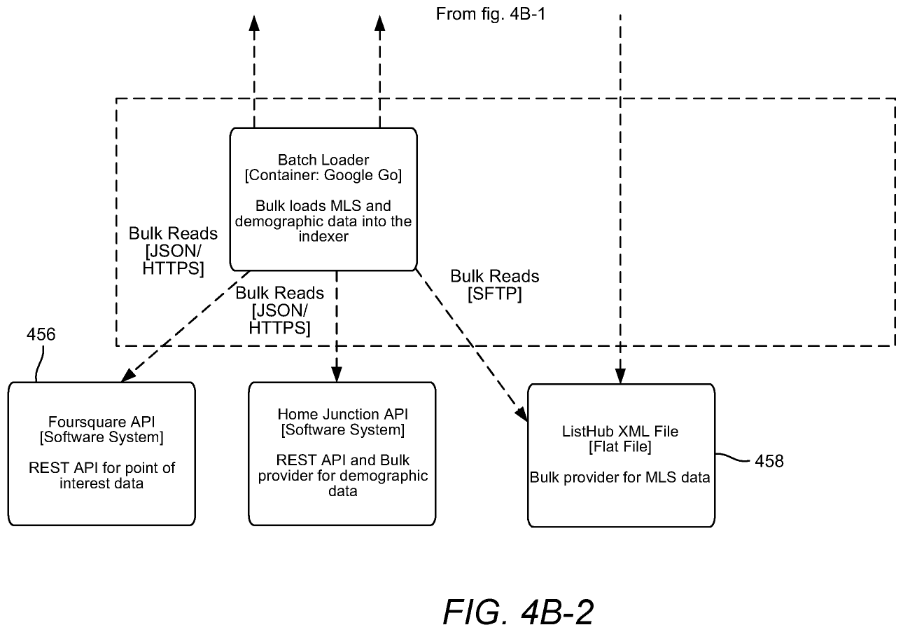

FIG. 4A and FIG. 4B, illustrate another example container level architecture of a real property listing system of the disclosed technology. Similar to FIG. 3A and FIG. 3B, the example container level architecture illustrated in FIG. 4A corresponds to a public portion 400 while the internal (or private) portion 450 is illustrated in FIG. 4B. With respect to the public portion 400 illustrated in FIG. 4A, the same elements and interactions are provided as described above in FIG. 3A. In some aspects, there are one or more differences between the container level architecture 400 and the container level architecture illustrated in FIG. 3A. Furthermore, there may be more differences compared to the highlighted elements below between the internal (or private) portion 450 illustrated in FIG. 4B with respect to the architecture illustrated in FIG. 3B.

In some aspects, internal (or private) portion 450 of the property match similar shares many similarities with the components and interactions illustrated in FIG. 3B. In the example container level architecture, the internal (or private) portion 450 may include a number of additional elements that provides additional functionality to the property matching system. In some examples, an application sync software 452 has been included that is used to synchronize information between the internal (or private) portion 450 directly with the single-page application within the public portion 400. Some advantages of disclosed aspects include providing an improved matching system by allowing for the updating of information that the customer may view and for information that the customer provides to be directly used by the property matching system (e.g., to update searches or customer preferences) that may impact the information stored within the dynamo database.

In some aspects, the internal (or private) portion also includes an elastic search place database 454 that is used to store information about properties that have already been enriched (e.g., property information that already has been incorporated with additional information from external sources). The enriched information that have been incorporated about the property may pertain to details about the associated properties as well as the respective boundaries of those properties. Whereas the elastic search listing (described in FIG. 3B) may be used to store enriched information about property listings that the property matching system has available, the elastic search places 454 can also be used to store those same property listings. In some situations, when there are two places to store the property listings that the property matching system has, priority between where to store those listings can be performed. In some situations, property listings that are not being used in any current property listing matches can be stored in the elastic search places 454 while those property listing matches that are being provided to customers can be stored in the elastic search listing, as illustrated in FIG. 4B.

As shown in FIG. 4B, the elastic search listings database interacts with the match engine, which in turn communicates to the customer public portion of the property matching system. In some examples, the elastic search places 454 can be used as a standalone database for holding the information that is not currently in use with a particular customer's match preferences.

In addition to the Home Junction API (which was described in FIG. 3B as element 370), the architecture of the property matching system illustrated in FIG. 4B may also be able to use additional APIs alongside the Home Junction API in order to provide additional information usable by the property matching system.

In some aspects, additional APIs that can provide information for the property matching system to use may include a point of interest API 456 (which can be associated, in some cases, with Foursquare) provides information about various locations surrounding different properties (e.g., places to eat, tourist attractions, activities). In some examples, point of interest API 456 can utilize information associated with different points of interest available at respective sources (which in this case may correspond to information that Foursquare has in connection with nearby points of interest). This information may be helpful in finding properties that have corresponding customer preferences about living near (or perhaps avoiding living near) particular points of interest or points of interest in general. In some examples, customers may be able to utilize the information to identify whether certain points of interest (e.g., malls, amusement parks, restaurants) are nearby with respect to a particular property listing. Similarly, customers may be able to identify if other points of interest (e.g., train stations, bus stations, airports) are not nearby or avoid other certain points of interest.

In some aspects, a listhub XML file element 458 can also be used in connection with the property matching system. Whereas the Home Junction API (in FIG. 3B) may be used to collect both property and demographic information, the listhub XML file element 458 may be used to collect property information (e.g., MLS property data) while allowing the home junction API to mainly focus on gathering demographic information about the residents of those properties (e.g., renters, owners).

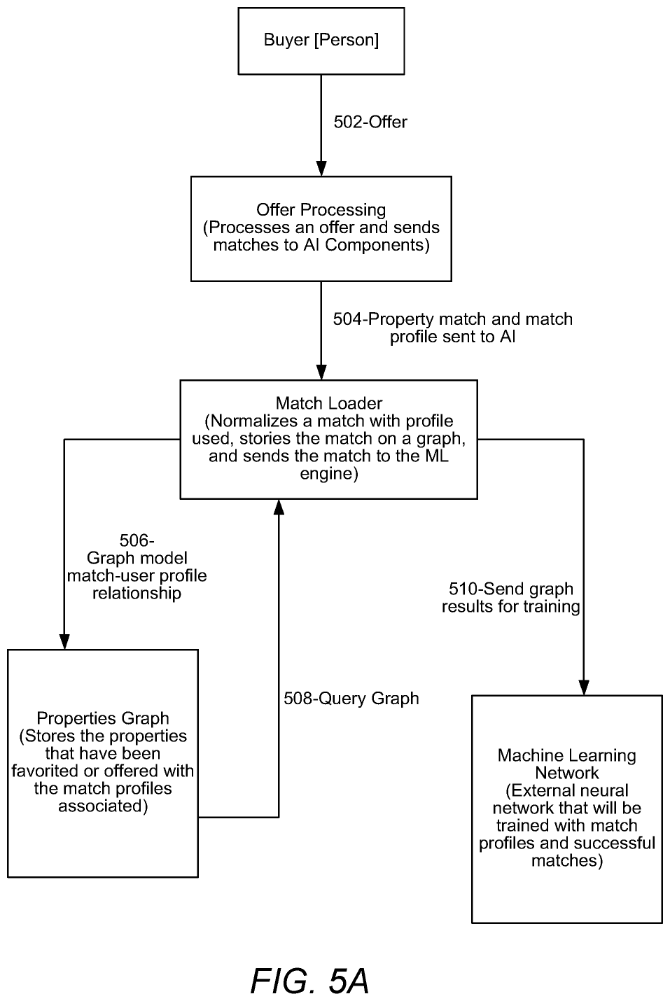

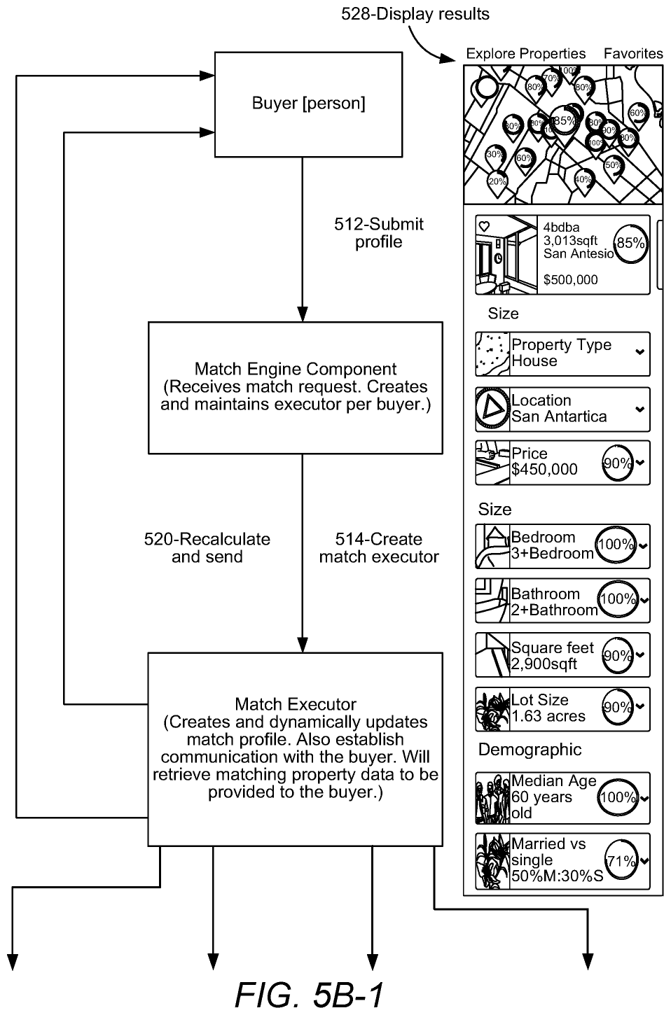

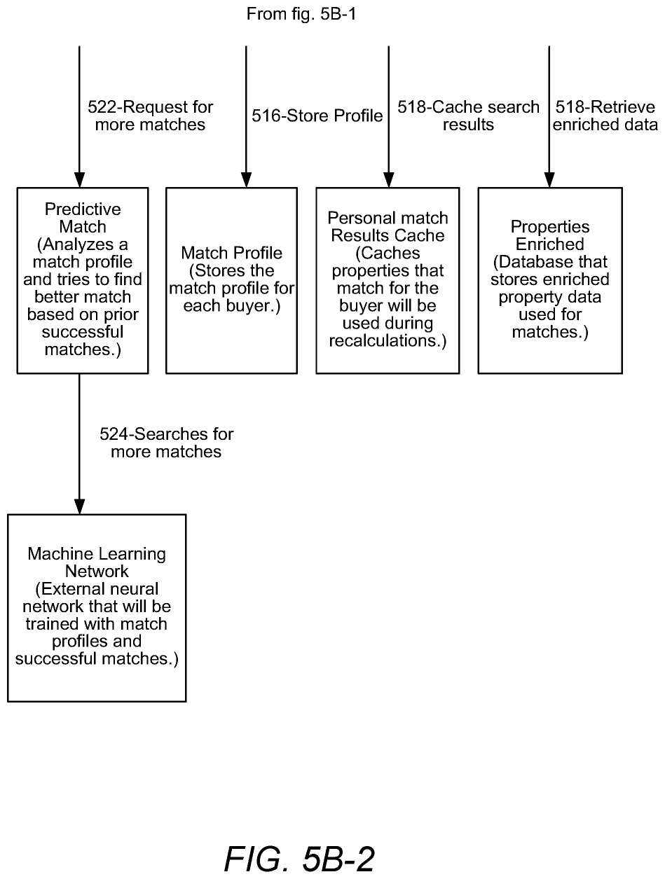

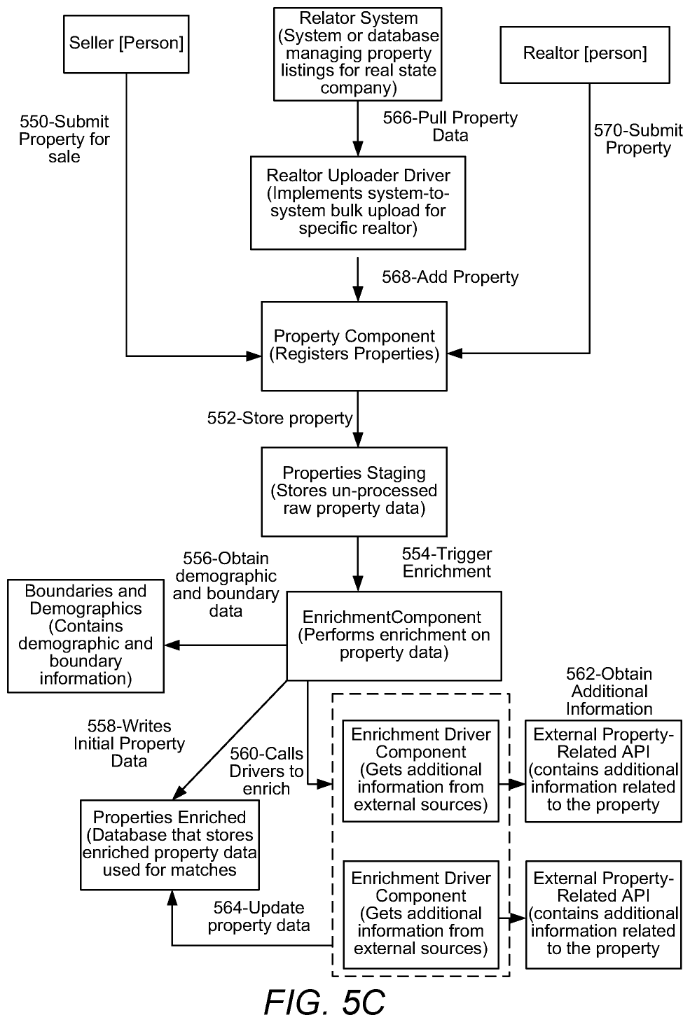

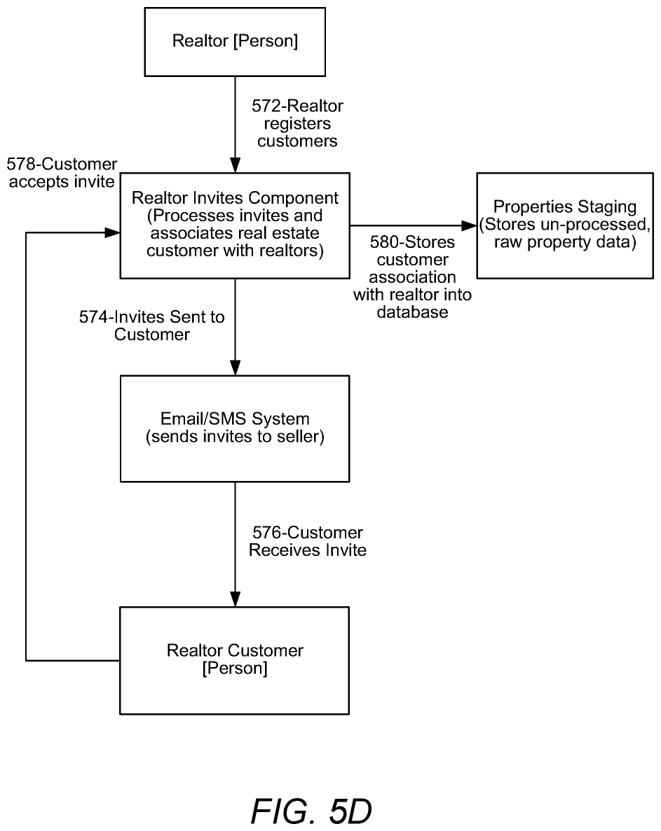

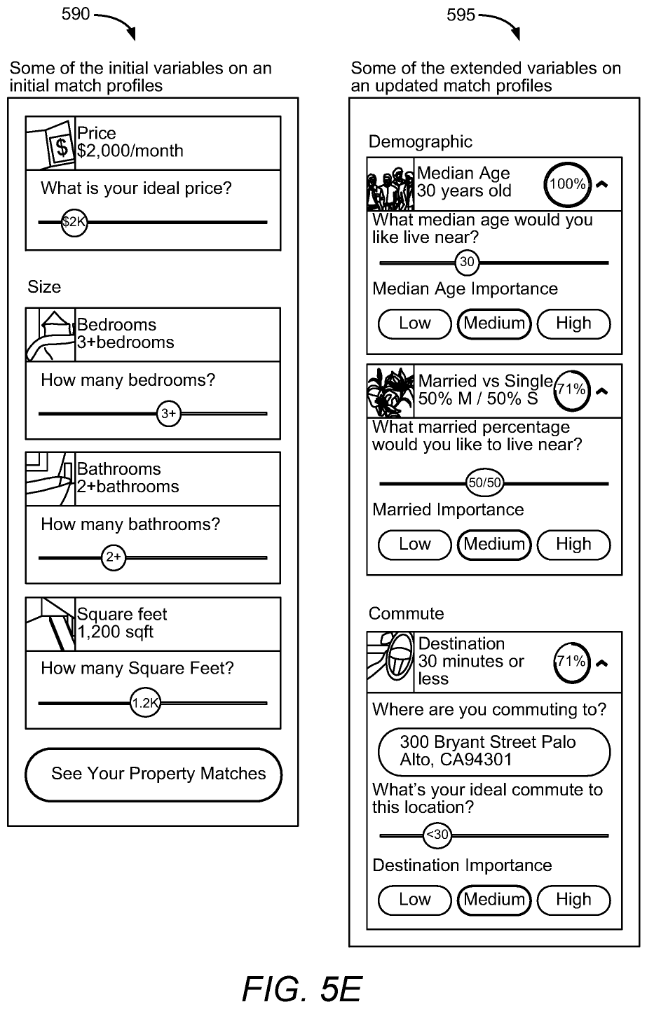

FIG. 5A-FIG. 5D, illustrate example flow charts 500 in connection with the property matching system. In particular, FIG. 5A and FIG. 5B illustrates the steps pertaining to a buyer purchasing a property and a customer looking for properties may use the property matching system. FIG. 5C and FIG. 5D illustrates the steps pertaining to how a seller and a real estate professional may use the property matching system. Details about each of the steps will be provided below. FIG. 5E illustrate some exemplary user interfaces associated with the performance of the steps illustrated in FIG. 5A-FIG. 5D.

With respect to FIG. 5A, steps 502-510 pertain to a buyer interacting with the property matching system. In step 502, the buyer makes an offer on property using the property matching system. An offer processing component can process the buyer's offer and send that offer to the AI components that will match the buyer's profile with the property in step 504. In step 506, the buyer's information (e.g., demographic information) can be associated with a match loader component that matches the user profile with the property. In some examples, a match can be modeled via a graph so that it can be used for machine learning training. In some examples, the graph can be stored within a properties graph database that stores match profiles of different buyers associated with the properties. In step 508, the graph database can be queried for any new relationships, in some cases based on a customer preference, based on the stored graphs pertaining to different buyer profiles. These graphs can be provided to the machine learning network in step 510 to train the machine learning network on how to identify matches between the properties and demographic information related to the buyer of the property.

With respect to FIG. 5B, steps 512-528 pertain to a customer's interaction with the property matching system, specifically requesting property listings that may correspond to the customer preferences. In step 512, the customer may submit an initial or updated profile to search for properties that match the customer's preferences. The customer may utilize a personal computing device (e.g smartphone, laptop, desktop) that may communicate with the property matching system. The machine engine component of the property matching system may respond back to the customer's computing device with an address of a channel that will be used to communicate with. The use of the channel can be used by the customer to securely transmit information about the customer to the property matching system and allow the property matching system to provide the matched property listings based on the customer preferences back to the customer computing device.

In some aspects, once the request is received by the match engine component, a match executor is created for the customer in step 514. In some examples, each customer interacting with the property matching system for the first time may be assigned a respective match executor that is configured specifically for the customer using information about the customer preferences. In some examples, the customer match profile can be stored and/or updated via step 516. If the customer continues to use the property matching system over a period of time, the same match executor can be used to maintain the customer profile and update information pertaining to the customer preference and/or properties that will be searched and/or matched. In some examples, match executor will be used to identify matches between property listings and the customer preferences. If any property listings match with the customer preferences, these properties may be provided back to the customer via the channel established in step 512.

In step 518, results that have been culled by the match executor based on customer preferences can be initially stored in a personal match results cache. These results may appear multiple times based on matching important categories related to the customer current preferences. In some aspects, properties that are stored in the personal match results cache can easily be provided to the customer whenever a request for property matches is received. In some examples, the properties stored herein can be used to recalculate match percentages which may be useful, in some cases, for re-calibration/machine learning to ensure that the property matching system is suggesting properties that more closely align to customer preferences. In addition, during step 518, enriched property data from various sources can also be retrieved based on the customer preferences at this time. In some examples, this data may be the same property data that is initially stored within the personal match results cache described above. This data can then be provided to the personal match results cache.

In step 520, the match executor is capable of recalculating matches and streaming the recalculated matches for properties back to the customer on their respective computing device. These recalculations can be performed at various times or upon request. In some examples, if the customer provides additional information or changes to any information about the customer that was previously provided, the match executor can recalculate the suggested properties that may match with the customer current preferences.

As indicated in the figure, step 520 may be specific to simple matches. This may be based on matches on property that have previously been suggested to the customer but can easily be filtered based on updated or additional information that the customer provided. In some examples, if the customer initially requested all properties within the city, the personal match results cache may initially store all property listings within the city. In some examples, if the customer provides information restricting the size pertaining to the location of where the property may be located, step 520 can remove the cached properties that do not fall within the more restrictive location. Other matches may correspond to properties that have or do not have specific characteristics (e.g., number of bedrooms, backyard). Any updates to matches that require additional processing compared to the simple matches performed in step 520 are instead are performed via steps 522 and 524. In some examples, updates on customer preferences pertaining to nearby points of interest or demographic-related information of residents nearby the property of interest may need to be performed via steps 522 and 524.

In step 522, the match executor can send the customer match profile to the predictive match component in order to perform non-evident matches using the machine learning engine. In some examples, the predictive match component will analyze the match profile of the customer (e.g., customer preferences) and the information related to the properties in order to find a group of properties that can better fit the customer's current preferences. In some examples, if the customer preference pertains to specific demographic information, the predictive match component may process the information regarding available demographic information related to each property and identify those properties that may best fit the customer preference. In some examples, if one of the customer preferences includes wanting to live within a community with other residents who share similar characteristics (e.g., age, marital status, income), the predictive match component would compare the customer's personal preference information and compare the preferences with other properties which also have those similar characteristics (e.g., have owners that fall within a preferred demographic). Afterwards, the information can be used to identify those property listings that may be nearby. In step 524, the predictive match component is able to find previous similar matches that resulted in an actual offer (as illustrated in steps 502-510) using the machine learning network. In some examples, matching of similar characteristics may be customer-specific and unless the customer provides a specific range, the property matching system may need to narrow the scope of similarity. In some examples, if the customer requests that the neighborhood be associated with younger families, the predictive match can look at previous offers from buyers who included those preferences and bought properties presumably in young family-based neighborhoods. The predictive match component can look at known information about nearby property owners and their relative ages and family composition and create a rule that can be used to filter properties that fall under this classification. This rule can then be used to influence the artificial intelligence used within the property matching system to identify properties that are possibly associated with neighborhoods where young families are located.

Using the information from steps 522 and 524, the property matching system can then recalculate a match for the property based on the customer preferences. Any outputs can then be provided to the customer in step 526. The outputs can be illustrated, as an example, on a map that displays the matched properties in step 528. The map may include information, such as percentages, that show how close the property matches the customer's preferences. A separate list detailing each of the properties illustrated on the map may also be displayed. The map and/or list can be updated on a regular basis or whenever new matches are available.

With respect to FIG. 5C and FIG. 5D, various other flow charts are illustrates that involve sellers and/or real-estate agents. In FIG. 5C, steps 550-564 are associated with a private seller providing their property to be listed using the property matching system. Furthermore, steps 566 and 568 pertain to how a realtor's system can upload properties to the property matching system. Lastly, step 570 pertains to how a realtor can upload properties to the property matching system. With reference to FIG. 5D, steps 572-580 pertain to another interaction of how realtors can register a potential seller's property within the property matching system. The relationship between the seller and the realtor can be used to generate reports and related analysis.

With reference to FIG. 5C, step 550 shows that a private seller can use their computing device (e.g., mobile device, laptop, desktop) to access the property matching system. The access can be performed, in some examples, via a mobile web browser or a native mobile application. Once the seller is able to access the property matching system, the seller can be provided the ability to submit a property to be listed (and subsequently used for matching with potential buyers/customers).

In some aspects, the property information that the seller may like to list is received by the property component. The property component of the property matching system may then save the property listing provided by the seller within a staging data store in step 552. The staging data store is used to store unprocessed and raw individual records of property. In other words, this may be information that the seller provides using the mobile web browser or native mobile application but is not formatted or organized in any manner. In some examples, one or more pieces of information about the property as well as information about the seller may be missing.

In some aspects, once the seller's property is initially stored within the staging data store, this triggers the property matching system to begin processes to enrich this property listing with additional information from various different sources in step 554. In some examples, the boundary and demographics component of the property matching system can provide known demographic and geographic boundary information for the areas related to the property listing in step 556. These additional information about the property (which the seller may not have provided or may not have known) can be useful in assisting in identifying whether this property is located in an area that the customer is interested in as well as provide information about the neighborhood or surrounding area that the property being listed by the seller is part of. In some examples, other types of information can be used to enrich the property listings provided by the seller.

Once this enrichment has been completed, the property can then be stored in a database that is used to store enriched property data in step 558. The data stored in the enriched property data base can be used for searches and matches performed by the property matching system. In some examples, as illustrated in the figure, customers may request display of properties that correspond to customer preferences regarding various demographics. The search and match of what properties may satisfy the customer preference may be drawn from the enriched property database. As indicated above, additional information can be used to enrich the seller property listing (performed in step 556). In particular other enrichment components can be called at any time or when available (e.g., asynchronously) to add information to the property listing over time in step 560. In some aspects, when additional data is added to the property listing, the property matching system may be able to provide more specific matches regarding the properties in relation to the customer preferences. In some examples, further enrichment to the property listing can be performed at various times or when information is available to be updated.

In some aspects, additional enrichment carried out in step 560 is based on enrichment driver components that are used to get information related to the property from external data sources. Each of the drivers that may be used in connection with the property matching system can correspond to a different data source and used to retrieve and incorporate the information stored therein (as in step 562). In some examples, each of the enrichment driver components may have a corresponding API associated with external sources that allows the respective component to be notified when information about a property is available and to provide the information to incorporate with the property listing.

Once the information has been retrieved from the external source and used to enrich the property listing, the enrichment driver components can be used to update the enriched property database in step 564. These updates can occur as the property listing data is finished being enriched with the additional information. In some examples, these updates can be performed at various times.

In addition to the seller, there may be systems available that can be compatible with the property matching system in order to provide updates and new available property listings for use with the property matching system. As illustrated in FIG. 5C, a realtor system may be a system or data store that manages property listings for a real estate company. If this real estate company would like to utilize the property matching system described in this present application, the real estate company may provide the property information they have available (as illustrated in step 566). The information can be provided from the realtor system to the property matching system using, in some cases, an upload driver. The upload driver can implement a system-to-system bulk upload of all available property data to the property component of the property matching system (as illustrated in step 568). This upload can be performed upfront with all available information when the realtor system first uses the property matching system. Afterwards, the data from the realtor can be provided at various times (or alternatively when new property data is available). Once the information for the properties have been provided from the real estate company, the information may undergo the same steps of being processed, enriched, and stored for use with the property matching system as described above in connection with steps 552-564.

Like the seller, real-estate agents are also able to provide property listings for use by the property matching system. In some examples, in step 570, a real estate professional may be able to use their own computing device (e.g., mobile device, laptop, desktop) to access a mobile application or mobile web browser in order to connect with the property matching system. In this way, the real-estate agent (much like the seller in step 550) can provide one or more properties to be listed with the property matching system. In some examples, one or more properties may be provided to the property component from where the same steps 552-564 are performed. Whether the information comes directly from the seller or from a realtor, the information is processed and stored in the same manner.

With reference to FIG. 5D, steps 572-580 describes how the relationship between a realtor and a seller may be stored within the property matching system. This relationship may be important as this may allow the seller to access additional information using the property matching system. In some examples, the real estate agency may include information about market pricing or demographic information related to the property of the seller that may be helpful in valuing that property. The seller may be able to access this information if the seller works with the realtor associated with the real estate agency.

In step 572, the realtor can provide to a realtor invitation component details to a customer on how to register. In some examples, the realtor can provide an email or SMS number that would be used by a potential seller to be associated with a realtor. The invites are sent from the realtor invitation component to the seller in step 574. Depending on the method the invitation would be carried out, the correspond platform would be used (e.g., email/SMS system). In step 576, the seller would receive the details to connect with the realtor. The email and/or SMS number may require that the seller confirm the invitation (in step 578). The confirmation then allows the relationship between the seller and the realtor to be stored within the property matching system.

With reference to FIG. 5E, two exemplary graphical user interfaces 590, 595 are illustrated. These graphical user interfaces 590, 595 aid customers in submitting different preferences that can be used to search for property data. For example, graphical user interface 590 lists general property-related information such as price, number of bedrooms, number of bathrooms, and how much area (in square feet) the property has. Customers are able to input their preferences, for example, via a slider that can be moved to a point corresponding to the customer's preference. Alternatively, customers may be requested to select an appropriate number or input the number in a designated area. Once these preferences have been filled out, the customer may initiate an initial search by confirming the preferences and requesting that the initial search be performed using the inputted preferences (e.g. by interacting with the ‘see your property matches’ button).

The graphical user interface 595 provides other additional information that a customer can also input and use to filter properties. Similar to the graphical user interface 590, the customer can provide preferences such as a preferred median age of nearby residents, preferred marital status of nearby residents, and preferred commute time from the property to a current work location. With each of these preferences, the customer would be able to indicate how important the preference. The importance correlates to a weight that will be used by the property matching system to identify properties that may directly satisfy the customer preference or may deviate from the customer preference by pre-determined ranges. For example, if the customer indicated that having a commute time less than 30 minutes is of medium importance, properties that may range from 30-45 minutes may be provided. If the customer indicated that having a commute time less than 30 min is of high importance, then only properties less than 30 minutes may be provided.

The graphical user interface 595 may also include an indicator (e.g. a percentage) that initially informs the customer how many of the properties that the property matching system has fall under that preference. If the percentage is too low, this may be used to notify that the customer may wish to loosen the preference more in order to view more different properties.

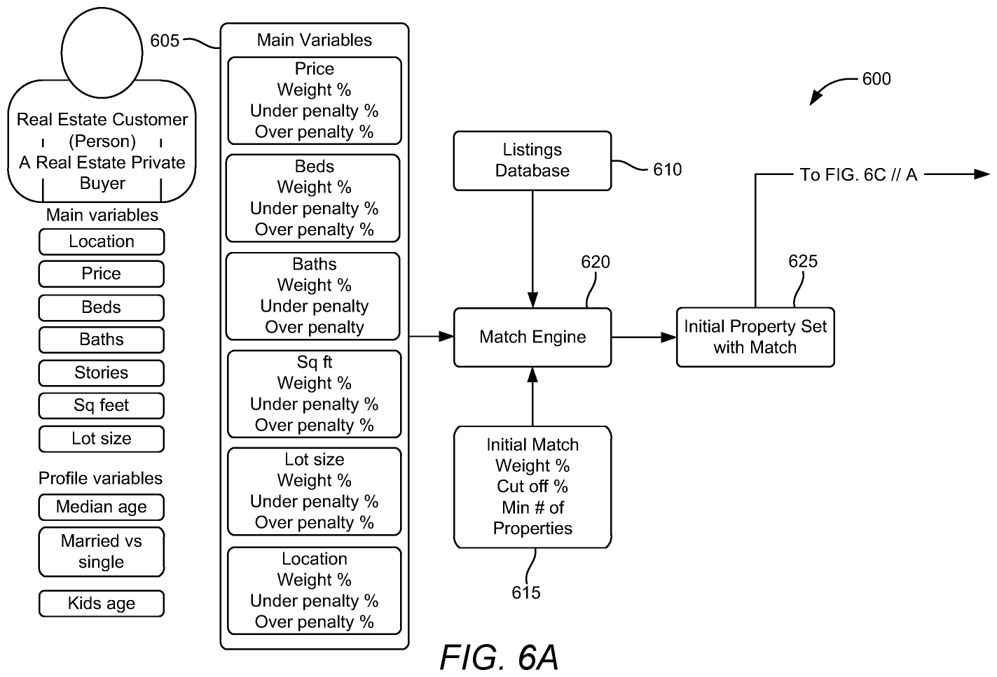

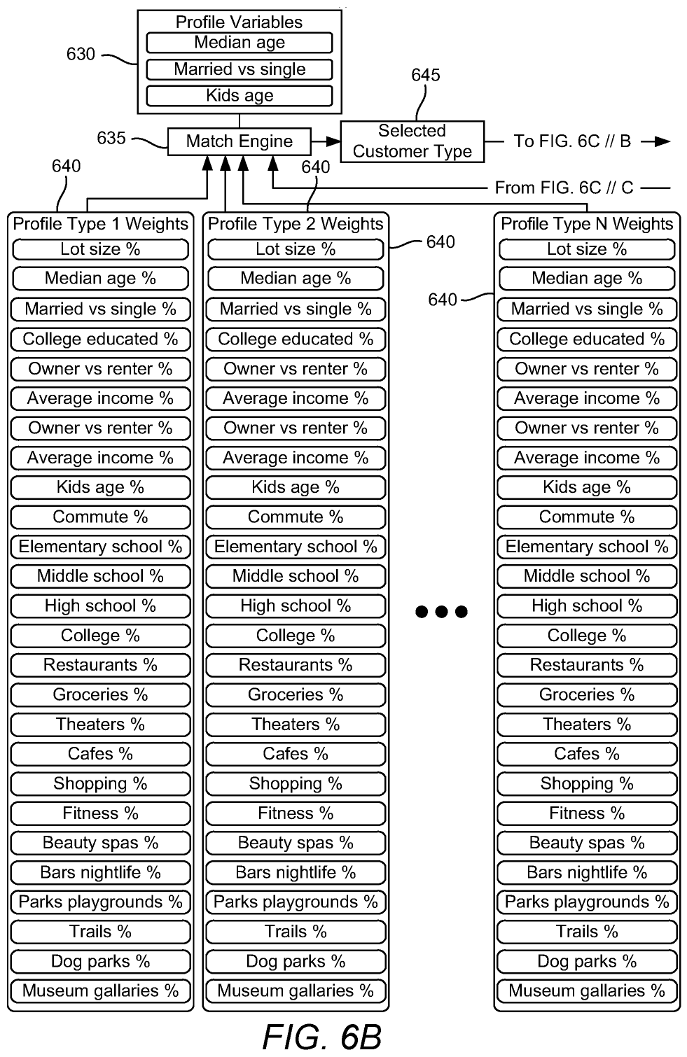

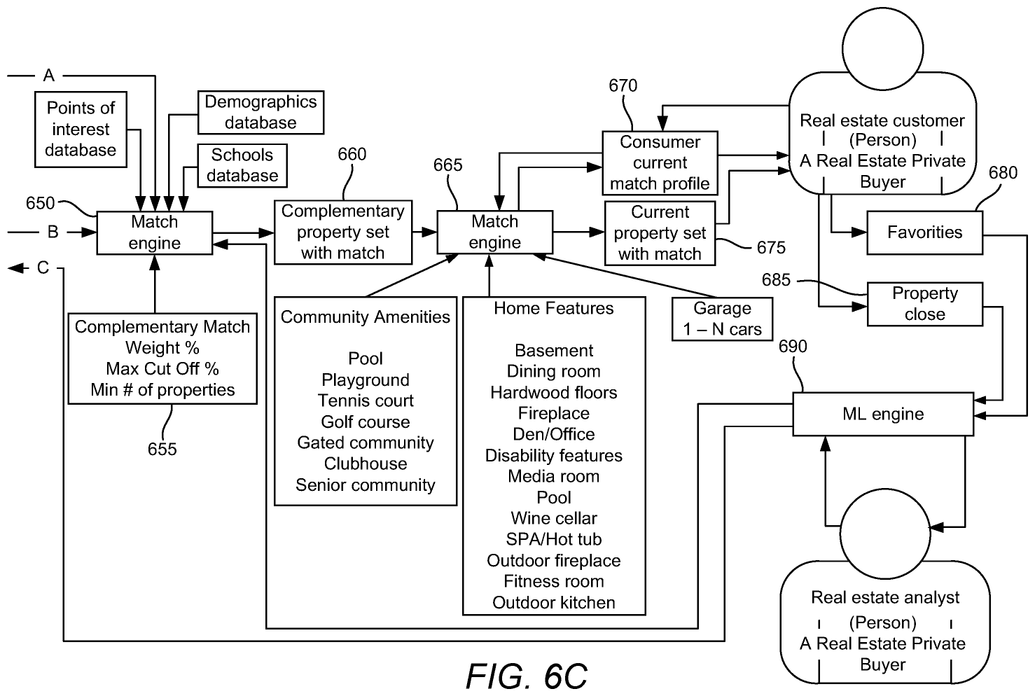

FIG. 6A-FIG. 6C, illustrate an exemplary match logic based on disclosed aspects. The match logic illustrates various exemplary logic that is used to identify properties that match with a customer's preference and thus may be property that the customer may have interest in. In particular, FIG. 6A illustrates a first match that is performed based on main variables associated with the property, FIG. 6B illustrates a second match that is performed based on demographic information pertaining to the customer and nearby residents, and FIG. 6C illustrates a further match that uses the first and second match (from FIG. 6A and FIG. 6B) and further filters the property listings before providing the properties to the customer. There may be many other possible embodiments that are also possible that can be used to similarly filter property listings, as described above, using customer preferences.

In some aspects, main variables 605 are taken from the consumer input and used to calculate an initial match of properties that the customer may be interested from all available property data that the property matching system may have stored within the listing database 610. In some examples, each variable has an independent weight and may have a pair of penalties applied to it if the value from a listing is above (over penalty) or below (under penalty) a desired value entered by the consumer. The main variables are used to gather an initial (e.g., broad) list of properties via the match engine 620 that will be further analyzed in FIG. 6B and FIG. 6C for the consumer in search of a match. From the initial match other parameters 615 can control how many properties can be gathered. In some cases, a cut-off percentage can be used to increase performance and provide matches that are more closely aligned with the customer preferences. In some examples, the minimum number of properties identifies at least how many properties may first be gathered via the initial match. Once the initial grouping of properties are found in the initial match, this initial group can then be gathered and sent off for further filtering 625 (as discussed above with respect to FIG. 3C).

As illustrated in the figure, there are a variety of different types of main variables. In some examples, common variables may include 1) the location of where the property is located, 2) the price/price-range of the property, 3) the number of bedrooms the property has, 4) the number of bathrooms the property has, 5) the number of stories/floors the property has, 6) the total area or square footage of the property, and 7) the total area or lot size on which the property itself resides on. With each of these main variables, a customer searching for a property may customize the factors to more align to what they are interested in.

In some aspects, a customer may provide a desired number of bedrooms the customer may want in their home purchase (e.g., 4 bedrooms). The number of bedrooms can be provided a corresponding weight in relation to each of the other main variables being weighed. In some examples, if the customer is part of a family of 4, it may be important that 4 or more bedrooms are available in the property so that each member of the family can have their own room or that there are sufficient rooms for other purposes (e.g., office/workspace). Over and under penalties may be applied to reflect the importance of this main variable. In some examples, the customer may consider properties with more than 4 rooms (thereby providing a low over penalty) but more likely to dismiss houses with 3 or less rooms (thereby providing a high under penalty). In some examples, based on how the other main variables are weighted in connection to the number of rooms, there may be situations where properties that do not satisfy the 4 room customer preference can still show up.

Moving onto FIG. 6B, a second match engine 635 is used to calculate a complementary match using the initial customer-based profile 630 that are selected by the consumer. In some examples, customer-based profile may be based on a number of different variables that the customer may provide or select detailing preferences that the property should be associated with such as 1) median age of nearby residents, 2) marital status of nearby residents (e.g., single or married), and 3) whether nearby residents have kids and how old their kids are. These selected preferences may highlight the factors that may be most important to the customer in performing the second match via the match engine 635. In some examples, the customer may want to 1) live by nearby residents that are similar in age, 2) that have similar marital status, and 3) have kids that are similar in age. Properties that satisfy these criteria can be identified and shown to the customer as these will most likely be the ones that interest the customer the most.

Each customer may also have their respective profile 640 stored within the property matching system. Each of these profiles may have any number of different factors that may be of interest to a customer in deciding what properties to purchase. Although details about the illustrated factors will be provided below, more, less, or different factors may also be included in other embodiments.

As illustrated in the figure, there are a number of exemplary factors that customers may provide information/preferences that may be used to filter and identify property matches. For example:
Lot size %—corresponds to a customer's preferred property lot size. This may be used to identify if the property has additional land besides what is used for the home. The additional land may be used as a backyard, garden, or for other outdoor purposes.
Median age %—corresponds to a customer's preferred age of nearby residents. This may be used to identify the age of nearby residents within an area, such as if a customer may wish to live in a neighborhood where other residents of the property of interest are around a specific age (e.g., similar to the customer).
Married vs. Single %—corresponds to a customer's preference regarding whether nearby residents are single or married. This may be used to identify if the nearby residents of the property of interest are part of a family-oriented neighborhood.
College Educated %—corresponds to a customer's preference regarding whether nearby residents have achieved some level of college education.
Owner vs. Renter %—corresponds to a customer's preference regarding whether nearby residents own the property they are currently residing in or if they are renting the property.
Average Income %—corresponds to a customer's preference regarding the income of nearby residents. This may be used to identify if nearby residents of the property of interest are within the same income range.
Kids Age %—corresponds to a customer's preference regarding the age of their kids. This could be used to identify if nearby residents of the property of interest have kids and potentially be used to identify neighborhoods that their own kids around their kids' age.
Commute %—corresponds to a customer's preference regarding commute time. This could be used to identify properties that are a certain distance away from the customer's current job. This could take into account traffic and other factors (e.g., closeness to freeway/toll roads) to identify properties that fall within the desired commute time.
Elementary/Middle/High School/College %—corresponds to a customer's preference regarding schools that are nearby. This could identify the location of the school, the quality of the school, and any other factors that could be used to identify whether that school may be desirable or not desirable for the customer's kids to attend. Properties that fall within schools having certain characteristics could be filtered and shown.
Restaurant %—corresponds to a customer's preference regarding restaurants that are nearby the property of interest. This could be used to identify where restaurants are located, the types (e.g., cuisine, quality, price) of restaurants, and even if the customer wants to be within a certain distance of a certain restaurant.
Groceries %—corresponds to a customer's preference regarding grocery stores that are nearby the property of interest. This could be used to identify where the grocery stores are located, what chains are nearby, and even if the customer wants to be within a certain distance of a certain grocery chain.
Theaters/Cafes/Shopping/Fitness/Beauty Spas/Bars Night Life/Parks/Playgrounds/Trails/Dog Parks/Museums %—similar to Restaurants and Groceries above, each of the factors listed above can be presented to the customer to provide a preference regarding whether that factor is located nearby the property of interest. This could be used to identify specific points of interest that are nearby the property and even if the customer wants to be within a certain distance of a certain point of interest.

The customer may select any number of factors provided via the profile variables 630, the stored profile variables 640, and also utilize input from a machine learning engine (e.g., artificial intelligence) illustrated in FIG. 6C of the property matching system in order to generate a customer profile type 645 that attempts to summarize what the features of the customer. The customer type 645 may be used to further filter the initial match (obtained in FIG. 6A) as illustrated and described in connection with FIG. 6C.

By using the profile variables 630 and the profile type weights 640 in this manner as described above, the customer may be able to identify specific aspects of each of these factors to influence the types of properties that would be shown that best satisfies the customer's preference. If the enrichment data associated with the property matching system is able to obtain information about these factors, the customer's preference will be carried out as much as possible. In some examples, requesting that the parks/playgrounds have swings within the same neighborhood as the property of interest may be a customer preference. Depending on the sources of information, the property matching system may be capable of identifying that there are parks and/or playgrounds within the same neighborhood. If possible, the property matching system may utilize other sources to identify if the park/playground has swings. If not, the property matching system may provide a detailed notification to the customer informing that the match identified that a park/playground is nearby but that no information regarding whether the park/playground has a swing is available. This notification could be used to inform the customer regarding what the match is based on. Furthermore, once the information becomes known (e.g., the customer goes and confirms that the park/playground has a swing), the information about the property can be updated accordingly.

Once the initial match has been completed (in FIG. 6A) and the customer type has been generated (in FIG. 6B), these two may be combined via a third match at the match engine 650 in order to further filter the property listings obtained in the initial match. At this point, information from various other databases (e.g., points of interest database, demographics database, schools database) may be queried in order to filter properties based on the various profile variables and profile type factors (illustrated in FIG. 6B) that are applicable to the customer. Using these additional data sources, the match engine 650 would be able to identify properties, in some cases, that are nearby schools with high ratings, AND that are within neighborhoods with residents having similar ages, marital status, and/or are nearby parks. In some examples, other types of databases are also compatible with the property matching system in addition to the ones illustrated in FIG. 6C. The properties identified via the match performed by the match engine 650 can similarly be pruned by parameters 655 similar to what was performed earlier in FIG. 6A (with element 615). The parameters 655 can control how many properties can be gathered. In some examples, a cut-off percentage can be used to increase performance and provide matches that are more closely aligned with the customer preferences. In some examples, the minimum number of properties identifies at least how many properties may first be gathered via the initial match.

After the match and pruning has been completed, a complementary set of properties that match the customer preferences are obtained 660. A further match 665 can again be performed using more additional resources that identify, in some cases, various features associated with the neighborhood and the home that the customer may be interested in. In some examples, community amenities that may be important to the customer may include whether there is a pool, playground, tennis court, golf course, or club house within the neighborhood, whether the community is a gated community, or whether the community is a senior community. Home features that may be important to the customer may include whether the property has a basement, how many dining rooms, whether the property has hardwood floors, fireplace, a designated den/office, a media room, pool, wine cellar, spa/hot tub, outdoor fireplace, fitness room, or outdoor kitchen. In addition, the customer may wish to know how large the garage is. More, less, or different features may be available in allowing the customer to further identify aspects about the property that the customer may prefer.

In some aspects, output of the further match being performed by the match engine 665 is then obtained in 675. These properties are provided to the customer to view on their computing device, in some cases, via a web browser or web application. When viewing the matched properties, the customer can continue to update their match profile 670 which in turn can be fed back to the match engine 665 and be used to update the matched properties being shown to the customer. The current match profile 670 may initially be created based on the selected customer type created in FIG. 6B but can be continually updated.

When the customer identifies properties that the customer likes, the customer can choose to favorite the property 680. This feature can be used to save properties that the customer would like to save. In some examples, the property matching system will use the favorites as a way to better train the machine learning engine 690 (or artificial intelligence) associated with the property matching system used to identify what properties may best match with the customer based on the customer preferences. When the customer favorites a property, the property data is fed into the machine learning engine 690 along with the user profile. The machine learning engine may then identify similar properties that the customer prefers. Based on the feedback of the customer (e.g., whether the customer also favorites these suggested properties or ignores them), the machine learning engine can improve the types of properties the customer prefers and attempts to better classify/characterize the customer's preferences.

In some aspects, when a customer actually closes on a property 685, the property data can be fed to the machine learning engine 690. Similar to when the customer favorites the property, the act of closing will allow the machine learning model to obtain information about the property and the user in order to reinforce, confirm, assess the accuracy of its predictions based on comparing the customer preference and the details about the property that correspond to the customer preference. In some examples, adjustments can be made across other customers that are participating within the property matching system when applicable (e.g., other customers share some of the similar factors that the customer who closed on the property also shared).

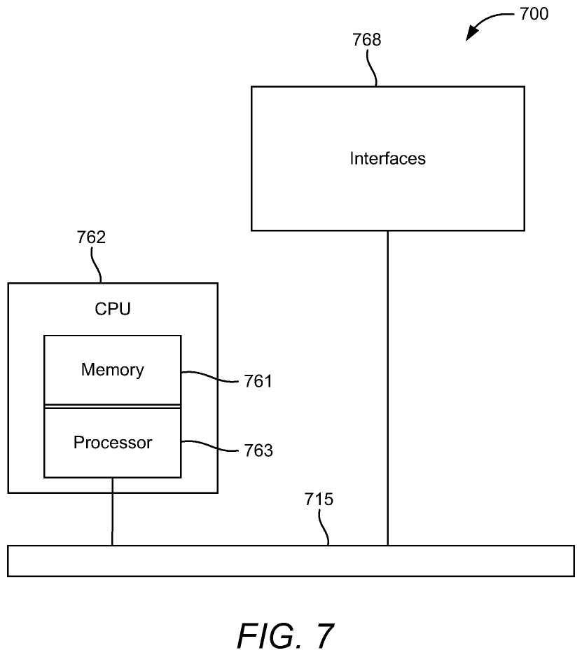

FIG. 7 illustrates an example processor-based device 700 that can be used to implement various aspects of the technology. In some cases, processor-based device 700 may be used to implement a real property matching system, as discussed above with respect to FIG. 1. It is further understood that processor-based device 700 may be used in conjunction with one or more other processor-based devices, in some cases, as part of a computer network or computing cluster. Processor-based device 700 includes a master central processing unit (CPU) 762, interfaces 768, and a bus 715 (e.g., a PCI bus). CPU 762 preferably accomplishes all these functions under the control of software including an operating system and any appropriate applications software. CPU 762 can include one or more processors 463 such as a processor from the Motorola family of microprocessors or the MIPS family of microprocessors. In some examples, processor 763 is specially designed hardware for controlling the operations of processor-based device 700. In some examples, a memory 761 (such as non-volatile RAM and/or ROM) also forms part of CPU 762.

In some aspects, interfaces 768 can be provided as interface cards (also referred to as “line cards”). Generally, they control the sending and receiving of data packets over the network and sometimes support other peripherals used with the router. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 462 to efficiently perform routing computations, network diagnostics, security functions, etc.

Although the system shown in FIG. 7 is one specific network device of disclosed aspects, it is by no means the only device architecture on which aspects can be implemented. In some cases, an architecture having a single processor that handles communications as well as routing computations, etc. is often used. Further, other types of interfaces and media could also be used with the router.

Regardless of the network device's configuration, it may employ one or more memories or memory modules (including memory 761) configured to store program instructions for the general-purpose network operations and mechanisms for roaming, route optimization and routing functions described herein. The program instructions may control the operation of an operating system and/or one or more applications, in some cases. The memory or memories may also be configured to store tables such as mobility binding, registration, and association tables, etc.

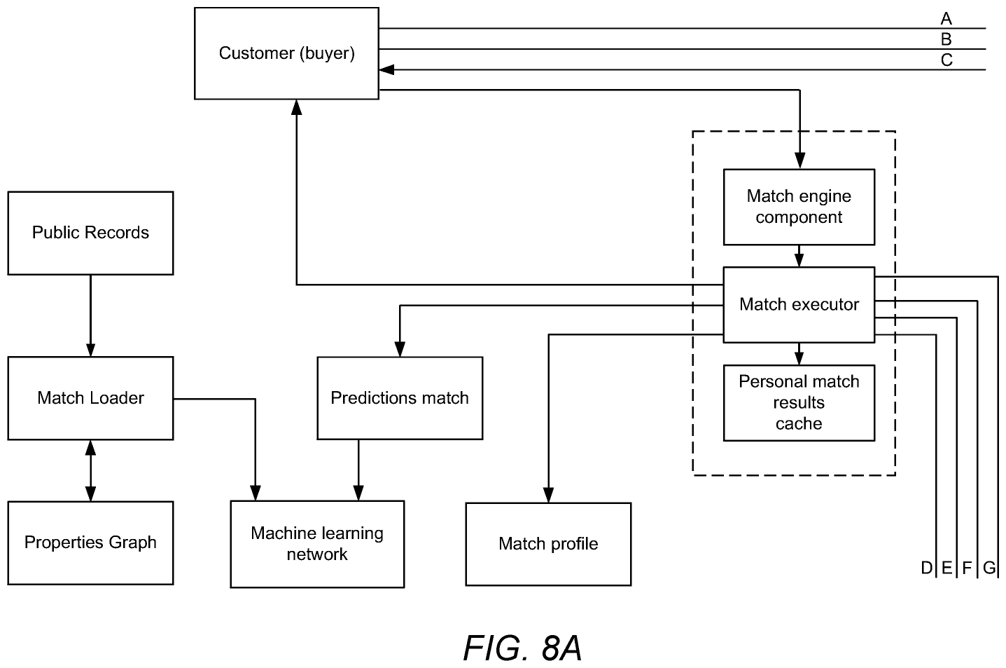

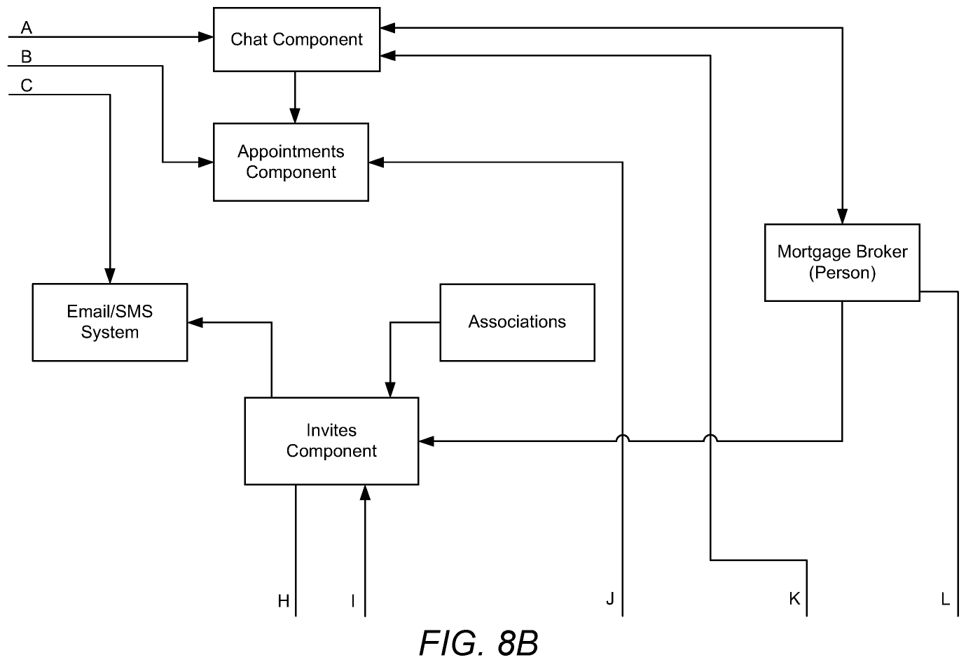

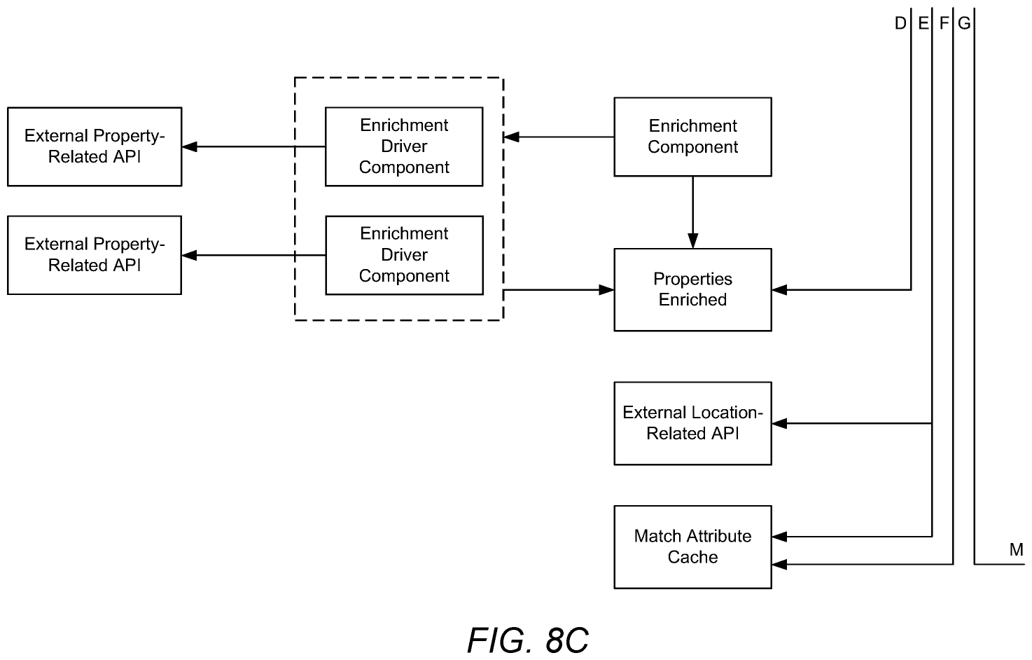

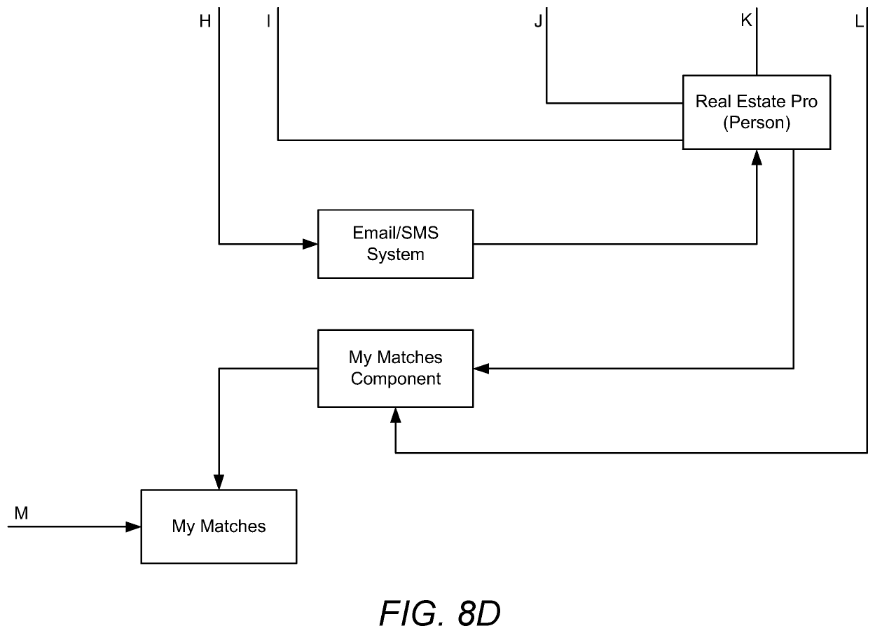

FIGS. 8A-FIG. 8D illustrate another exemplary flowchart of the property matching system. Similar to the flowchart illustrated in FIG. 5A-FIG. 5D, the flowchart in FIG. 8A-FIG. 8D shares many similar elements. However, what is different in this example embodiment that isn't illustrated in FIG. 5A-FIG. 5D is how the buyer (illustrated in FIG. 8A), mortgage broker (illustrated in FIG. 8B), and realtor (illustrated in FIG. 8D) are all interconnected within the property matching system. This interconnection is provided more distinctly via the use of the chat component and the appointment component (illustrated in FIG. 8B) that allows for a more streamlined communication between the parties.

As illustrated in FIGS. 8A-FIG. 8D, the three parties (e.g. buyer, mortgage broker, and realtor) can all interact with each other on the property matching system. For example, the three parties would be capable of communicating with each other via the chat component (illustrated in FIG. 8B) as well as through email and text (via the Email/SMS system). This allows all the different parties to be more easily in sync on the current state of a person (e.g. buyer) progress during the home buying process. For example, the realtor will be able to be kept in the loop on the loan process by the buyer and/or mortgage broker. Similarly, the mortgage broker can receive information about the property the buyer is interested in providing a bid for and can subsequently prepare the necessary loan calculations and approvals beforehand.

The chat component connecting the three parties on the same property matching system allows the parties to stay connected and informed about the progress during the home buying process. This is advantageous as this minimizes the opportunities where the parties may not be communicating with each other on a timely basis and can also minimize the miscommunications between the parties (e.g. he said/she said scenarios). Any issues can instead be raised in a chat (carried out by the chat component) so that all parties are on the same page.

Through the chat component, information about times and dates can be extracted and used by the property matching system to automatically suggest and schedule appointments based on the availability of each party via the appointment component. Each of the parties may have previously provided their availability into the appointments component or may have synchronized their own personal calendar with the property matching system. With the availability information, if dates and times for suggested meetings are being provided by the buyer for possible tours (with the realtor) or signing of necessary paperwork (with the mortgage broker), the appointments component can review the availability for the corresponding parties and suggest times that can be approved via chat, email or text. The appointment component can then provide an invitation to each of the corresponding parties so that the event (e.g. house tour, in-person consultation) can be accepted into their respective calendars. In some embodiments, the appointments component may also be capable of automatically updating the corresponding parties' calendars with the scheduled appointment if no other prior events were scheduled during the same time period.

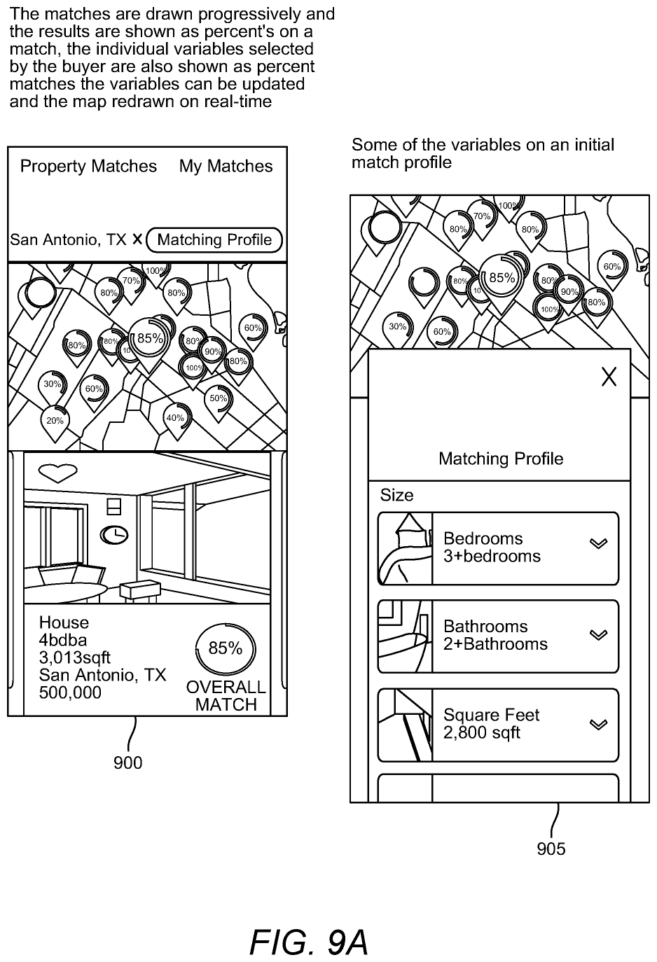

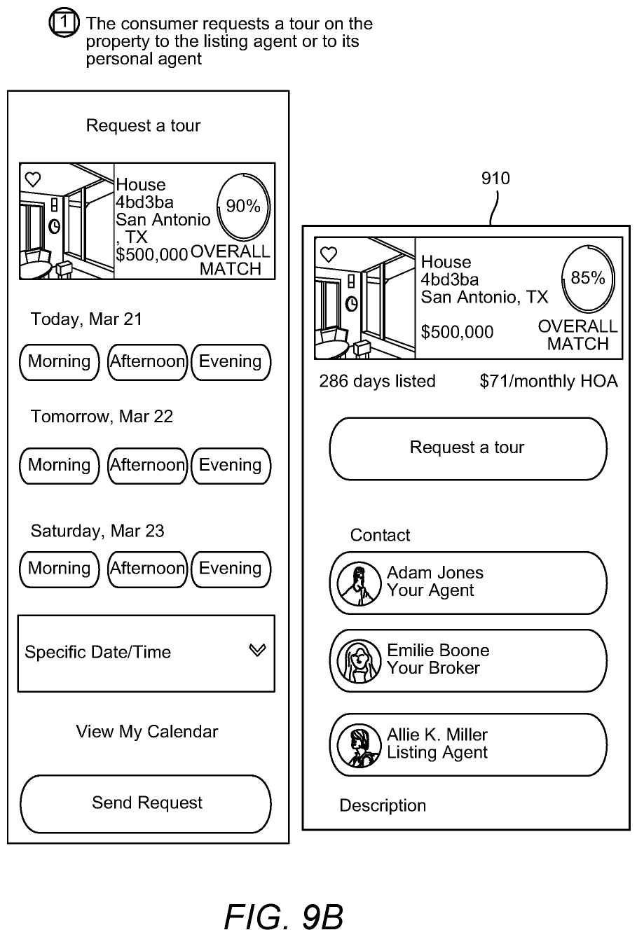

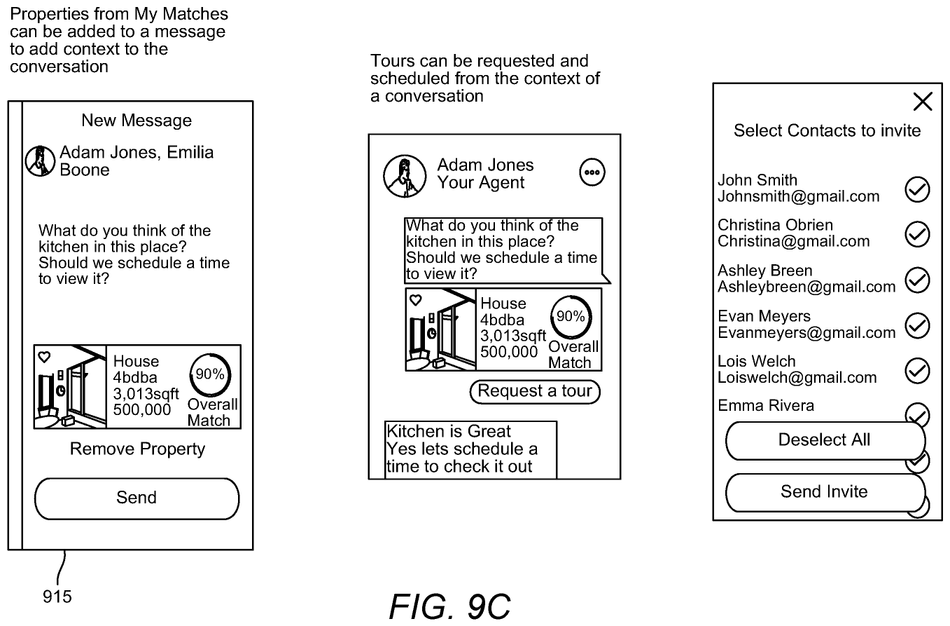

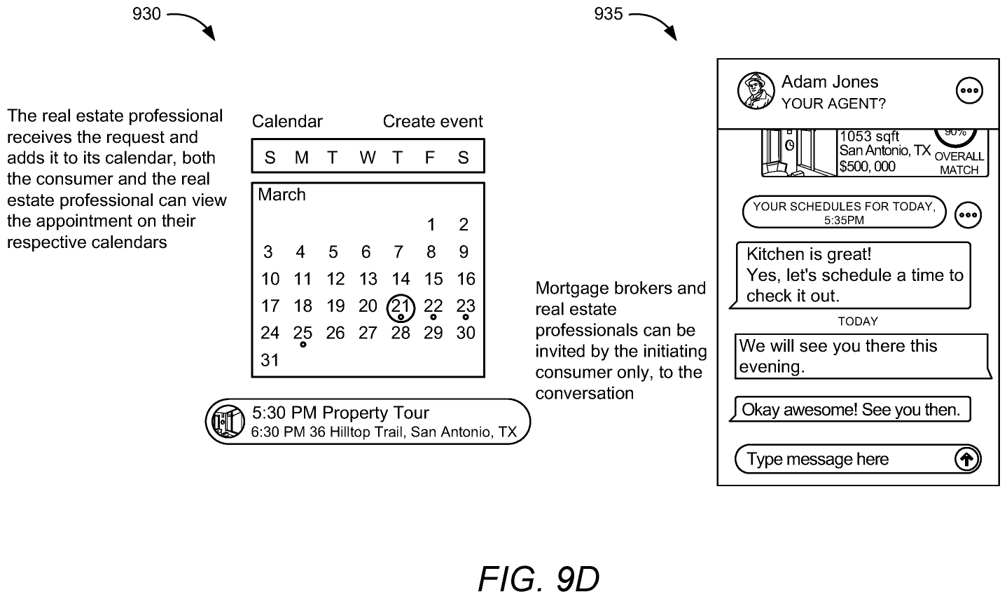

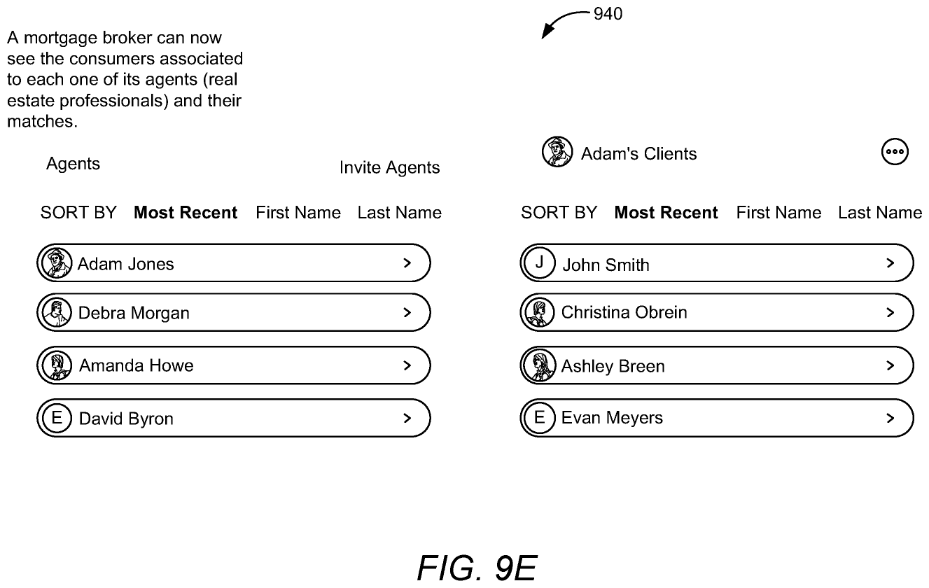

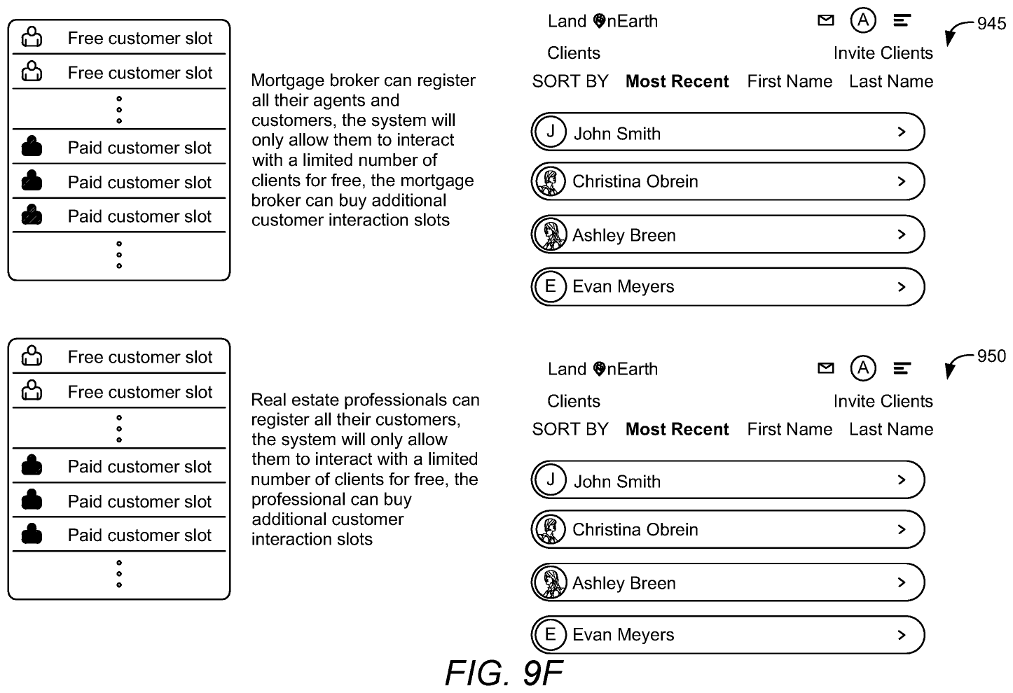

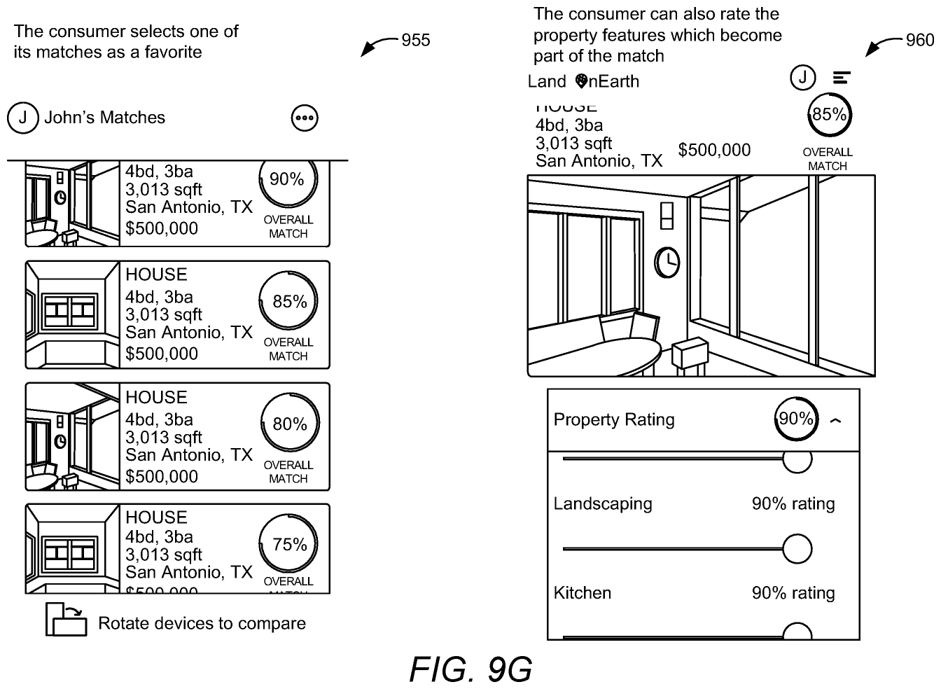

FIGS. 9A-FIG. 9G illustrate some exemplary user interfaces in connection with the flowchart illustrated in FIG. 8A-FIG. 8D. With respect to FIG. 9A, user interface 900 illustrates the property matches that correspond to the buyer personal preferences. The matches may also include information, for example illustrated as percentages, that can be used to indicate how close that matched property aligns to the buyer's personal preferences. User interface 905 illustrates some exemplary variables that can be modified by the buyer within the property matching system. For example, the buyer can select how many bedrooms, how many bathrooms, how many square feet, and how many stories. There may be many more and different variables that can be interacted with via user interface 905 by the buyer using the property matching system.

With respect to FIG. 9B, the buyer can use user interface 910 to request a tour of a property via the property matching system. When the user accesses a particular property that is displayed, for example, from the user interface 900 of FIG. 9A, user interface 910 can be provided that provides some of the information about the property, the available dates and times that a tour can be requested, various contacts the buyer can send this tour request to. For example, if the buyer is already connected to a mortgage broker and/or realtor, the tour request can be sent to them respectively. The property may be assigned a listing agent who can also be provided the tour request. The tour request being provided to each of these contacts allows for an in sync method of figuring out and planning when a tour involving the buyer, realtor, and listing agent can be performed. Information about the tour can be provided to the mortgage broker so that they can be aware of the types of properties the buyer is looking into and could potentially begin some initial loan calculations that can expedite the loan process.

With respect to FIG. 9C, example user interfaces and features in connection with the chat component are provided. User interface 915 illustrates how information about property matches can be added to chat conversations between the buyer, realtor, and broker. In this way, the buyer would be able to share more quickly the properties that the buyer is interested in. Similarly, the realtor would be capable of sharing property information in the chat to the buyer to make the buyer aware of possible properties that the buyer has overlooked. This feature allows the parties to quickly view the relevant property of interest without having to enter specific search parameters or look for that specific property.

User interface 920 illustrates how the buyer can request a tour just by typing a request within the chat conversation with, for example, the buyer's realtor. The property matching system would be capable of recognizing key words to identify when the buyer wishes to tour a particular home and parse/translate the conversation as a tour request (as if the buyer utilized user interface 910 in FIG. 9B). The tour request can then be automatically scheduled according to the appointment component as described above in FIG. 8B.

User interface 925 illustrates an example menu that includes the various contacts a party may have in connection with the property matching system. For example, the buyer may have various contacts (e.g. different realtors, brokers) that the buyer can then invite to a conversation as needed.

With respect to FIG. 9D, user interface 930 illustrates how various tour requests and appointments can be automatically generated and stored on a realtor's calendar. In response to a tour request, the appointment component can generate a reminder and illustrate it in the realtor calendar. In this way, the realtor can have the property matching system automatically manage the realtor's schedule with what date and time the tours are requested and with which buyer the tours are scheduled by. This allows the realtor to minimize double booking and streamline the scheduling process based on the realtor's available.

User interface 935 describes another feature in connection with the chat component. Specifically, it may only be possible by the buyer to initiate conversations with the mortgage broker and/or realtor. There may be situations where the buyer would only want to discuss certain things with one of the parties (e.g. broker or realtor) in which case a conversation can be created only between the buyer and that party. The invited party (e.g. broker or realtor) would not be allowed to invite other parties into that same conversation.

With respect to FIG. 9E, user interface 940 can provide a mortgage broker information about various different realtors who the mortgage broker is currently working with. These realtors may have previously worked with the mortgage broker on previous property sales and thus have shared contact information using the property matching system. The property matching system can list these contact information of the various realtors for the mortgage broker much like a directory where the mortgage broker can initiate calls, texts, chat sessions to obtain information about any ongoing property purchasing processes that are currently being done.

In some situations, the user interface 940 can also provide further information about each realtor. As illustrated in the figure, the user interface 940 may also include the contact information of each client (e.g. buyer) that is currently being represented by the realtor. The mortgage broker can use this information, for example, to reach out and contact the buyer (e.g. email, text, chat message) for any updates on ongoing property purchasing. In some cases, this communication may only be allowed if, for example, the buyer has shared contact information with the mortgage broker beforehand or has authorized receiving an initiated conversation from the mortgage broker that the buyer has not yet shared contact information with (e.g. enabling such feature via the property matching system).

With respect to FIG. 9F, user interfaces 945 and 950 illustrate an embodiment for both the realtor and the mortgage broker pertaining to their contact within the property matching system. One way the property matching system can be monetized is to provide a pre-determined number of “free” customer slots that can be used by the realtor and/or mortgage broker to save information about their clients. Such information may not only include their contact information (e.g. email, phone, chat) but also may include information about the person obtained during the course of the property purchasing process. For example, such information may include the buyer property preferences, search history, what tours the buyers went on, favorited properties, and any bids the buyers placed. Once all the “free” customer slots have been taken up, the realtor and/or mortgage broker may be required to perform certain actions (e.g. pay a pre-determined fee) to be allowed more slots. For example, the realtor and/or mortgage broker may be required to pay a flat fee for a predetermined additional number of slots. Another example may provide the realtor and/or mortgage broker with an unlimited number of additional slots under the condition the realtor and/or mortgage broker pay a subscription fee for a pre-determined period of time (e.g. monthly, quarterly, semi-annually, annually).

There may be additional ways for the realtor/mortgage broker can “earn” additional slots. For example, referrals of new realtors and/or mortgage brokers using the property matching system can be used as an incentive to provide the referrer some additional customer slots.

With respect to FIG. 9G, additional user interfaces 955 and 960 provide the buyer more ability to customize their searches in order to tailor searches for properties using the property match system. For example, user interface 955 allows the buyer to “favorite” or save properties that have been identified as possible matches with the buyer. The saving or “favorite”-ing of properties can be used to confirm what factors may have been more important to the buyer and thus modify the matching performed by the property match system.

User interface 960 allows buyers to “rate” the property and its associated features. The rating can be used by the property match system to identify what features were acceptable and what features were not acceptable to the buyer. By comparing the buyer's ratings with the buyer's property preferences, the match algorithm used by the property match system can further be tailored to identify properties with features that were more positively rated.

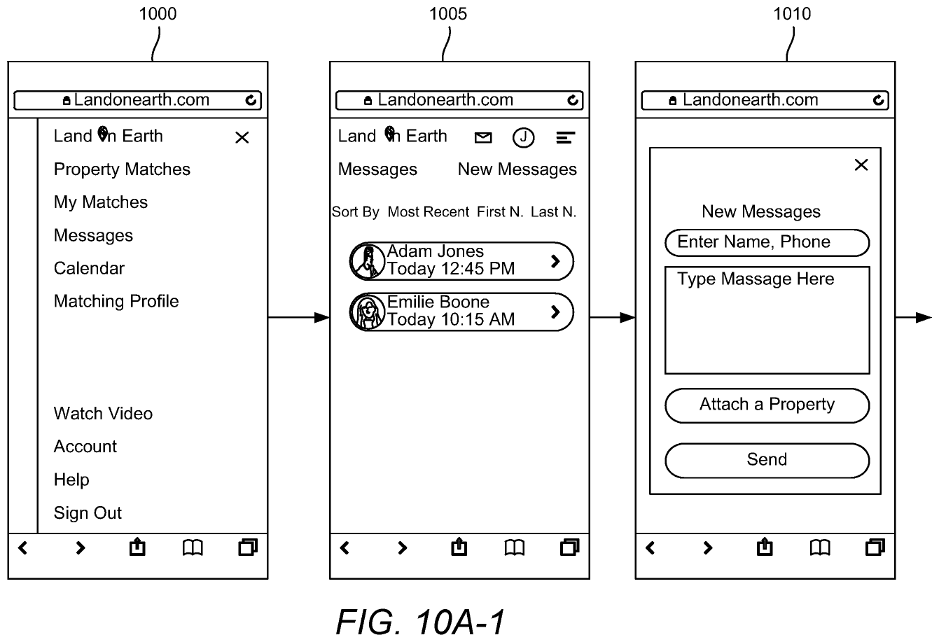

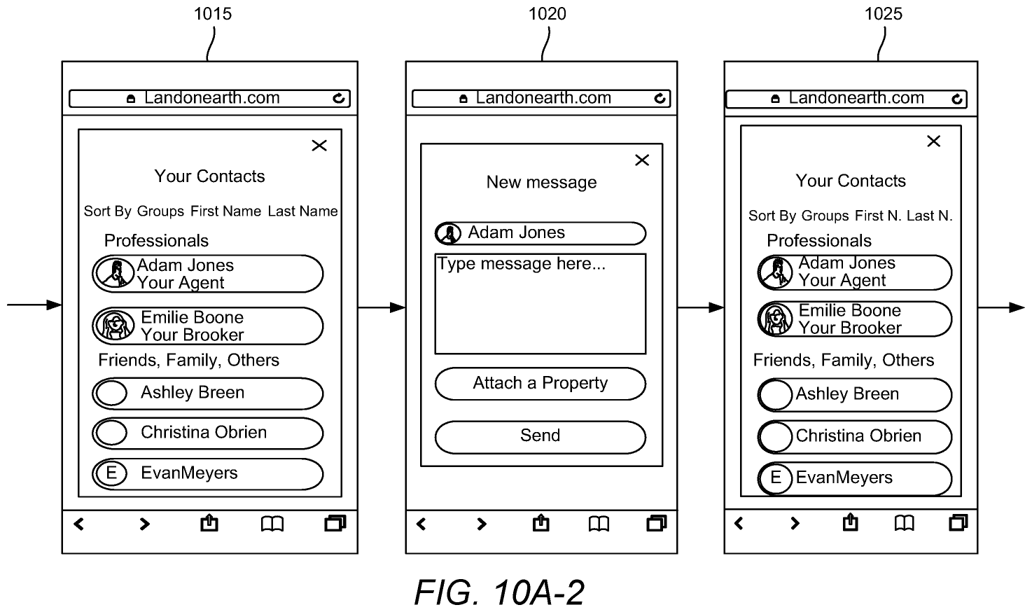

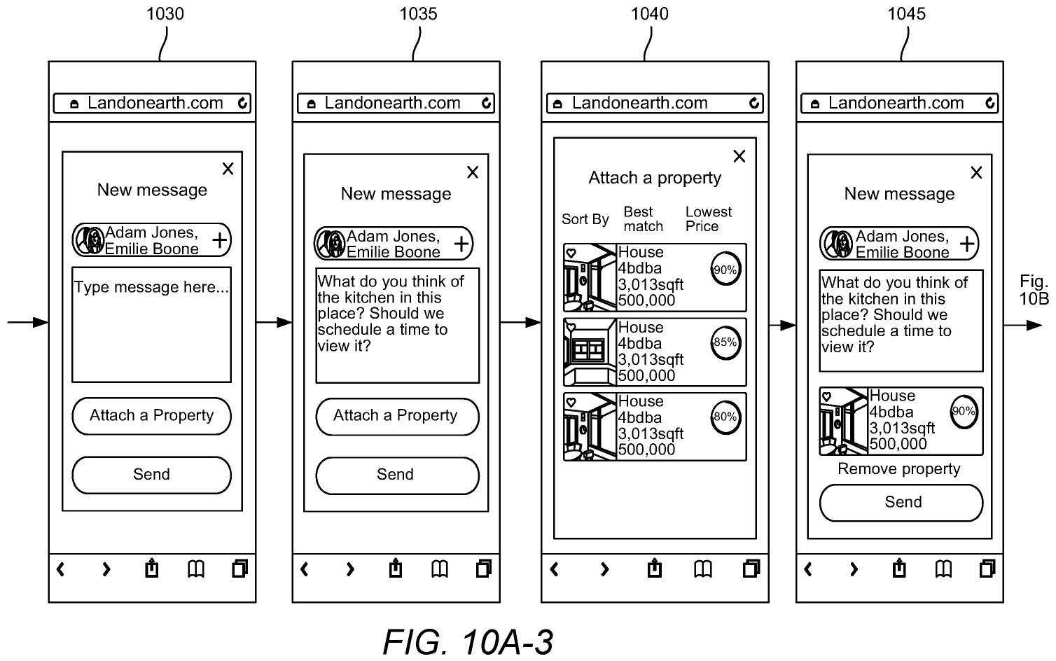

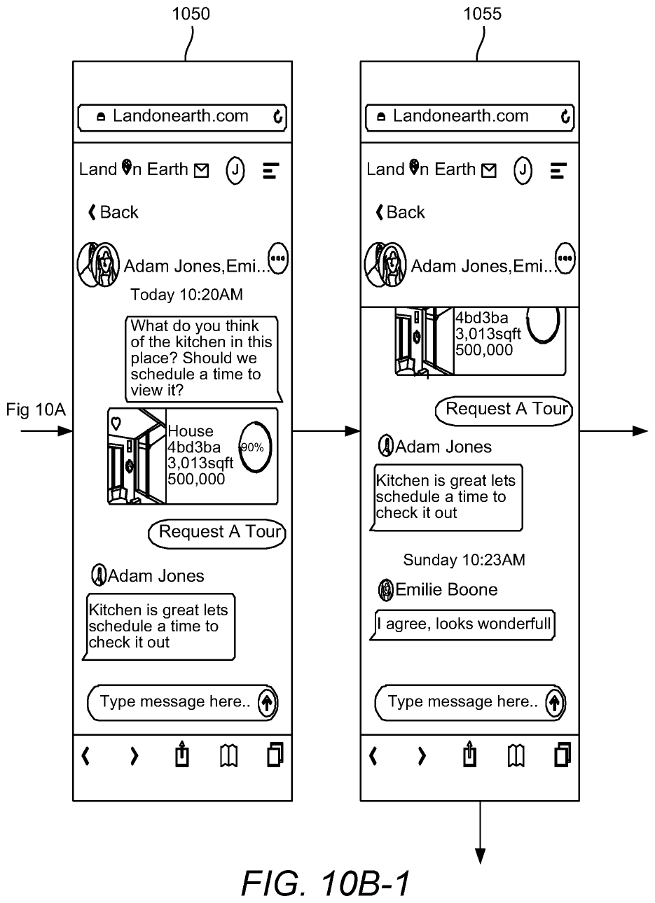

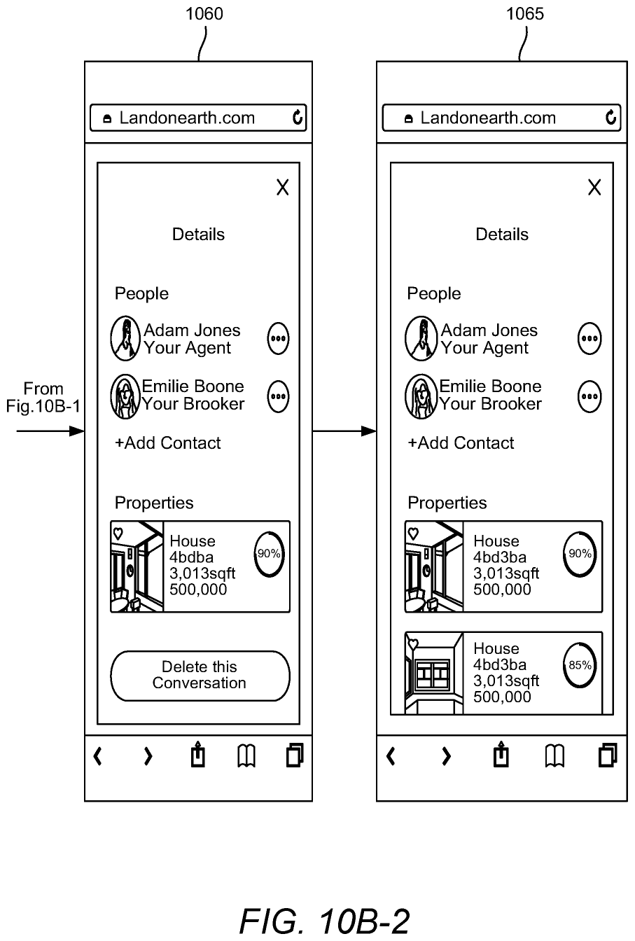

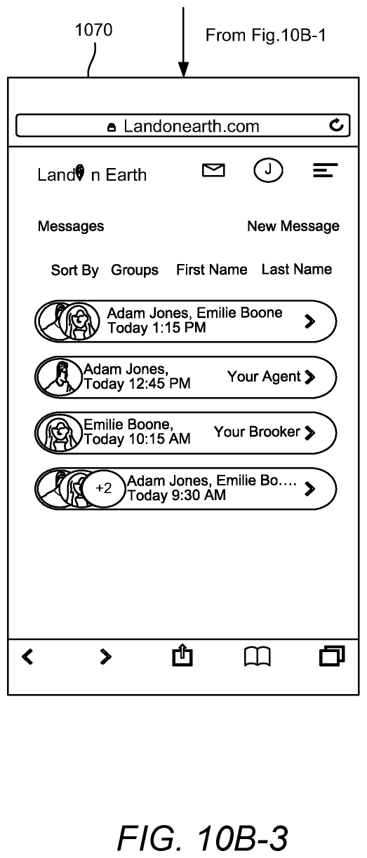

FIG. 10A and FIG. 10B illustrate an exemplary flow of different user interfaces that a buyer could see when using the property matching system. Specifically, the user interfaces correspond to the buyer creating new group messages.

User interface 1000 may be an initial main menu that the buyer sees when first accessing the site, for example, via a browser or mobile application. User interface 1005 may correspond to pending messages that the buyer may have pending that have not yet been read. The user interface 1005 may list the messages based on the most recent one received or based on the sender's name. User interface 1010 allows a buyer to create new messages and provide that message to one or more contacts using, for example, their name, phone number, or email. The user can also attach, for example, a property that the buyer is interested in. This feature may be useful, for example, for providing the buyer's realtor and/or mortgage broker the property that the buyer is interested in for purposes of scheduling a tour and/or for calculating a mortgage.

User interface 1015 lists the various contacts associated with the buyer. The contacts may be organized, for example, by groups or by names. If listed by groups, the groups can be customized based on the buyer's preferences. The buyer may choose to group all realtors and mortgage brokers within one group (e.g. professionals) and all personal contacts (e.g. friends, family) within another group. These contacts may be specific for the property matching system but can also include the buyer's personal contacts that have been uploaded, for example, via their mobile phone.

User interface 1020 shows that the buyer has selected a contact to send a message to. Selection of a contact from the list of contacts can automatically create a new message with the selected contact as the recipient of the new message. User interfaces 1025 and 1030 illustrate how the buyer can select multiple different contacts from the list of contacts (from user interface 1015) and include those different contacts within the same message. It should be noted that the user can select any number of contacts (e.g. 1, 5, 10) and may only be limited based on a pre-determined limit that could be imposed by the property matching system.

User interface 1035 illustrates that the buyer can customize a message to be sent to the recipients of the message. With the message, the buyer can attach one or more properties to share with the recipients. When selecting the “attach a property” button, a pop-up of the last matched properties can be displayed. The properties can be organized, for example, based on the properties that are best matched or the lowest priced. Other organizations may include identifying those properties that are favorited by the buyer. The buyer can select one of the properties illustrated in user interface 1035 in order to attach information about that property into the message (as illustrated in user interface 1040). The information about the property will be attached to the bottom of the message, as illustrated in user interface 1045.

When the buyer is ready to send the message, the buyer can click send. The message can then be sent to each of the recipients listed in the message. The message can appear as an email. In other embodiments, it may appear as an interactive messaging system, such as a chat box as illustrated in user interfaces 1050-1055. Each of the recipients can access information about the attached property by interacting with the box in the chat log. Furthermore, the buyer may be able to request/schedule a tour based on interacting with the ‘request a tour’ button. The property matching system may also be capable of identifying key words and parsing the buyer's intent with wanting to request a tour. In which case, the property matching system can suggest times based on the availability of the property, the realtor, and the buyer. User interfaces 1060-1070 show what the user interfaces look like once the buyer has completed using the chat log and decides to leave the conversation. If the buyer is finished with a conversation, the buyer can choose to delete the conversation as illustrated in user interface 1060.

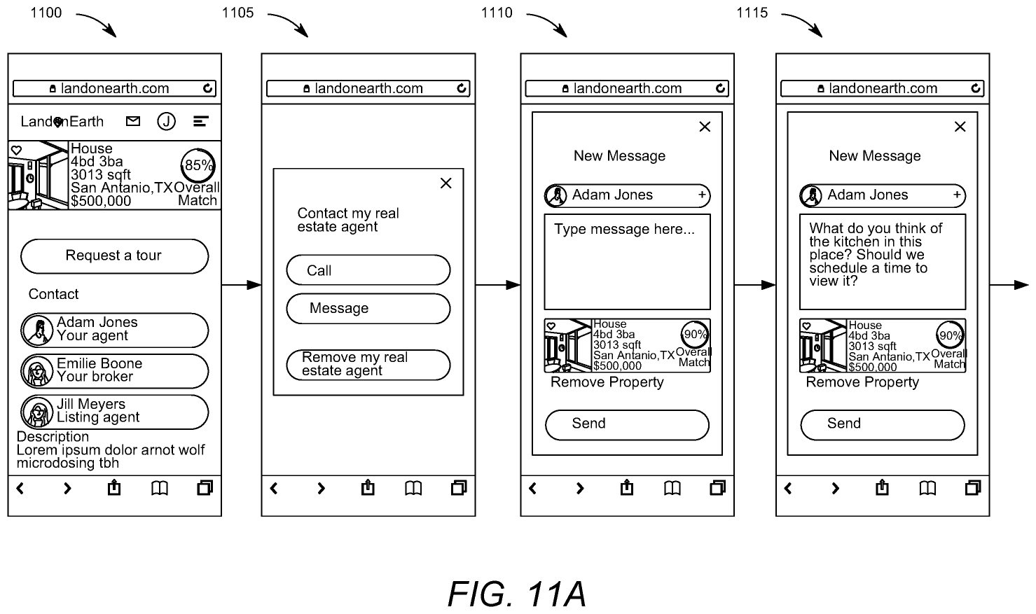

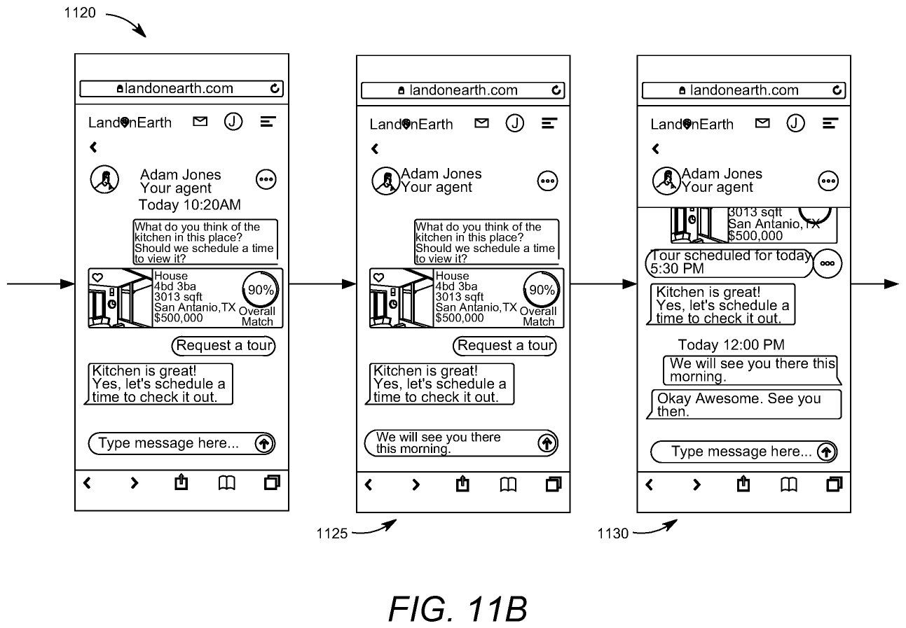

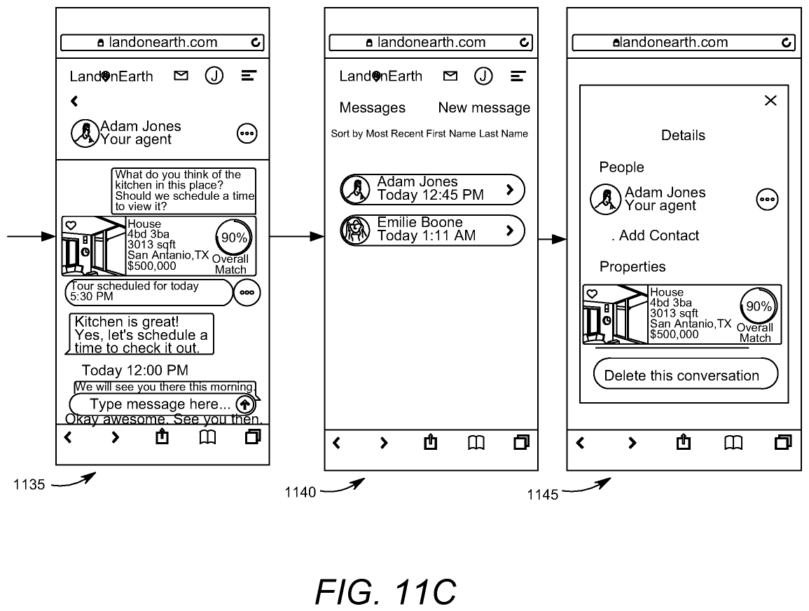

FIG. 11 illustrates an exemplary flow of different user interfaces that a buyer could see when using the property matching system. Specifically, the user interfaces correspond to when the buyer creates new messages directly from viewing a property profile.

User interface 1100 illustrates an exemplary display that shows property data about a property that the buyer is matched with. From the user interface 1100, the buyer can request a tour via the “request a tour” button. Furthermore, the buyer can initiate messages with one or more contacts listed on the bottom of the user interface 1100. Upon selecting a contact (e.g. realtor), user interface 1105 can be displayed that provides the buyer a choice on how to contact the contact (e.g. phone call, text message, or chat). The user interface 1105 can also provide the buyer the ability to remove the contact here if the contact is no longer needed. If the buyer selects the “message” button, user interface 1110 can be provided that generates a template for a new message with the matched property that the buyer was previously looking at. The contact's information is already filled into the message box so that the buyer only needs to insert a custom message (as illustrated in user interface 1115).

When the buyer is ready to send the message, the buyer can hit “send.” The message can be provided as an email. In other embodiments, the message can be provided in a chat log, as illustrated in user interface 1120. If discussions concern requesting a tour, the user interface can provide the option of scheduling a tour as illustrated in user interface 1125. The suggested time can be generated by the property matching system. When accepted, the property matching system can record it into the calendars of the buyer and/or realtor as well as set/send reminders based on the scheduled tour. User interfaces 1130-1135 illustrate the progression of conversations between the buyer and the agent. User interface 1140 illustrates an interface that illustrates all messages that the buyer may have pending with different contacts. User interface 1145 illustrates details about a particular contact and lists any properties that were previously attached in past conversations with that contact.

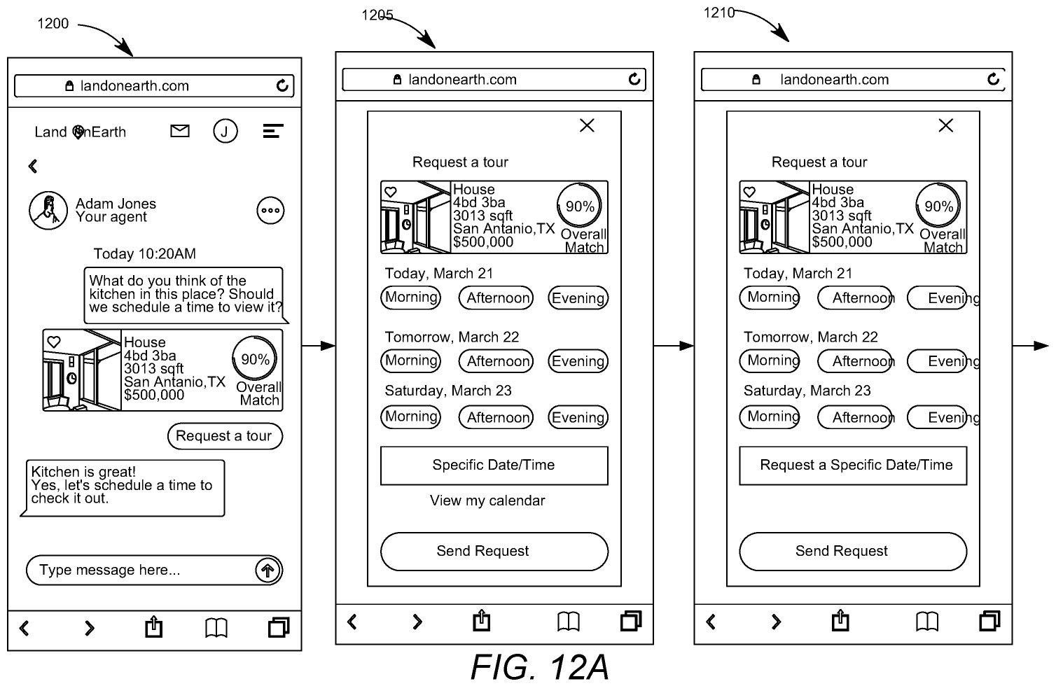

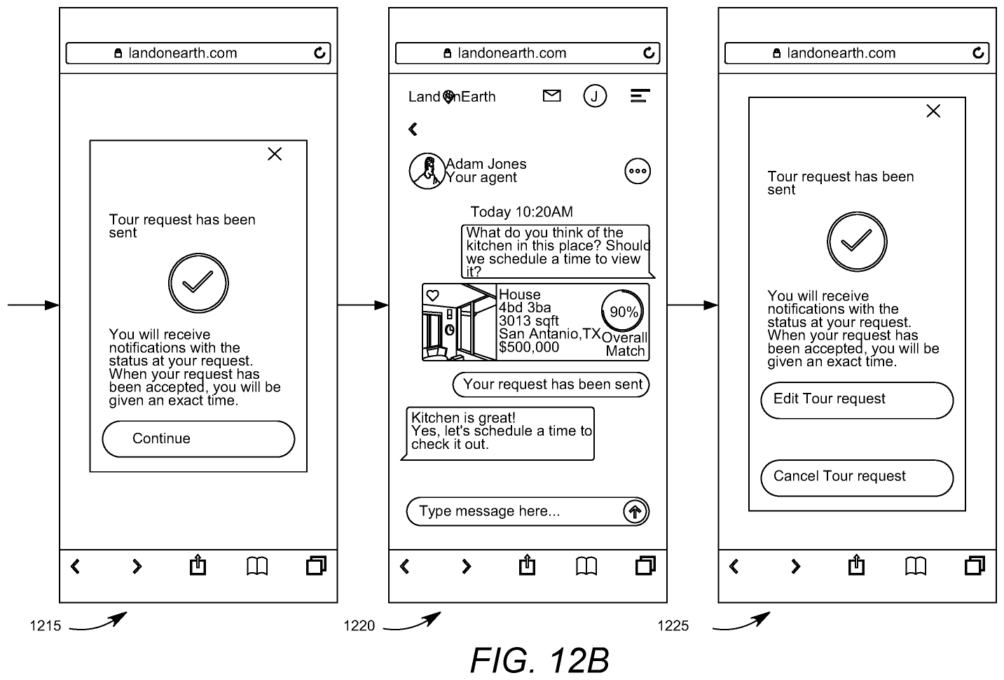

FIG. 12 illustrates an exemplary flow of different user interfaces that a buyer could see when using the property matching system. Specifically, the user interfaces correspond to when the buyer is allowed to request a tour while messaging.

With user interface 1200, a “request a tour” option can be displayed while the buyer is chatting with one or more other contacts (e.g. realtor). When the buyer selects the option, user interface 1205 is displayed which provides the details of the property that the tour is being requested along with general time frames of days and times that the buyer could indicate when the requested tour should take place. The buyer can also provide a specific date and time via a drop-down menu within the same user interface 1205. Furthermore, the buyer can also display their calendar in order to determine when they may be available. It may also be possible to display the calendar of the realtor if the realtor has their calendar uploaded/synchronized with the property matching system.

Once the buyer selects a general date and time (as illustrated in user interface 1210), the buyer can then transmit the request to the realtor. User interface 1215 indicates that the request was transmitted. The initial notification will indicate that the request has been provided to the realtor and that a follow up notification will be provided upon acceptance of the request by the realtor. In user interface 1220, the “request a tour” option has changed to indicate that a tour request for the property has been requested. On the realtor side, the realtor can confirm the tour request. At this point the property matching system would schedule the tour based on the suggested time for both parties. Alternatively, the realtor may suggest alternate times to the buyer. Furthermore, the buyer can also adjust/edit the requested tour date and time any point prior to the realtor accepting the tour request (as illustrated in user interface 1225). The buyer could also cancel the tour if, for example, the buyer finds another property and would rather check out a different property.

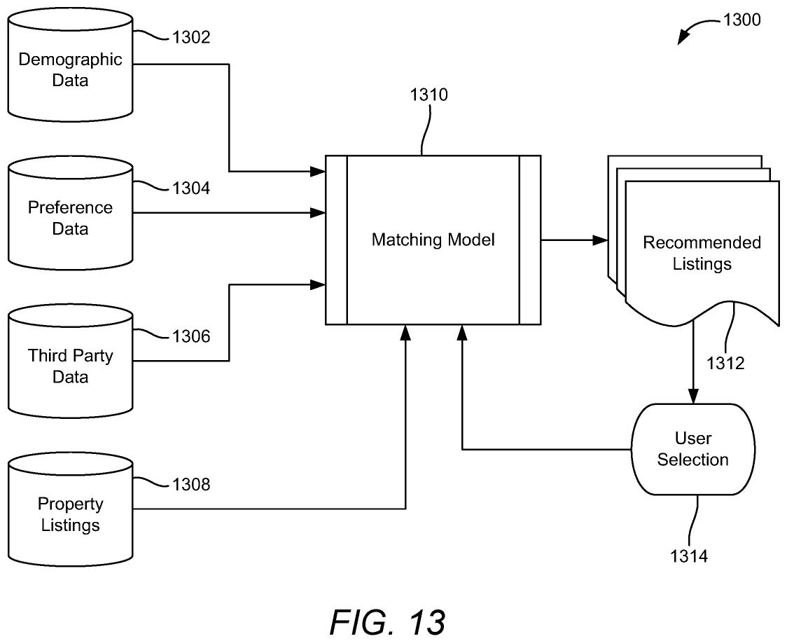

FIG. 13 illustrates a conceptual block diagram of a machine-learning (ML) implementation 1300 of a matching system of the disclosed technology. In some examples, ML implementation 1300 may use an ML based classification algorithm discussed above with respect to paragraph [0022]. In the example of ML implementation 1300, a ML matching model 1310 is configured to receive data from a variety of data sources (input space), and to output one or more recommendation listings 1312 (output space). Recommended listings 1312 can represent listings for one or more real-property assets that are determined to be of high relevance for a given user, or group of users. That is, recommended listings represent predictions of the mostly relevant matches for a given user associated with input data parameters. In some aspects, matching relevance is determined using ML models as discussed above with respect to FIG. 3.

In practice, matching model 1310 is configured to receive input data that is associated with one or more users, including but not limited to demographic data 1302, preference data 1304, third party data 1306, and/or property listing data 1308. It is understood that the various data inputs may originate from different locations, such as one or more online platforms, databases, and/or directly from the one or more users, for example, via a real-estate matching platform, as discussed above. By way of example, demographic data 1302, and/or preference data 1304 may be provided directly by a user, for example, via user interaction with a mobile application that is instantiated on a personal computing device (e.g., a smartphone, PC, or tablet computer, etc.), or other databases populated with user's information.

In some aspects, data provided to matching model 1310 may originate with one or more third-party databases or online resources. By way of example, third-party data 1306 may include one or more of: demographic data, preference data, and/or property listing data that is received from a data resource residing outside, or remotely from, matching system 1300.

As discussed above, the recommended listings 1312 can be provided to the user, for example, via a graphical user interface (GUI) that is displayed on a processor-based device associated with the user. Additionally, user selections of one or more recommended listings, for example, that may indicate the user's interest in those listings, and this selection may be used to update the relevance matching process performed by matching model 1310. That is, matching model 1310 can be configured for online-learning, thereby adapting the matching model in real-time (or near real-time) to feedback provided by the user or one or more other data/signal sources.

In some aspects, the recommended listings 1312 may be provided to someone that is associated with the user, such as a real-estate representative of the user. In this way, the user's agent or representative can also learn about the listings that are of interest to the user and may better serve them in their property search efforts. Additionally, in some aspects, the recommended listings 1312 may be provided to one or more sellers of real property, or seller agents and/or representatives, etc.

Some advantages of the disclosed embodiments include improved closing rates for realtors. With improved matchings of real estates, real estate agents will have to show less properties, do fewer open houses, and make far fewer cold calls to improve lead quality. This will result in faster transaction rates, less costs, and reduced search time for real estate transactions.

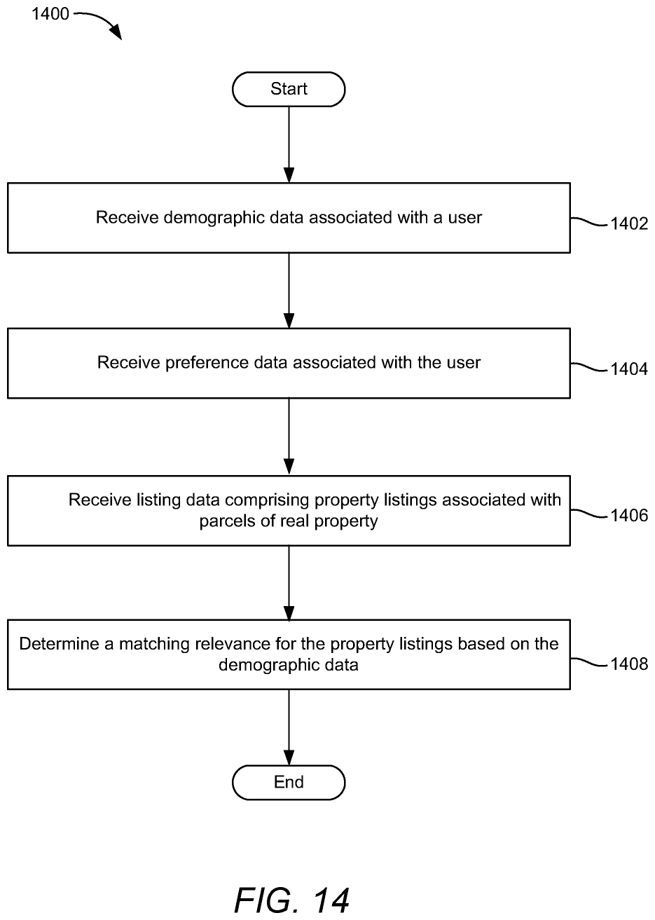

FIG. 14 illustrates steps of an example process 1400 for performing matching real-property listings with a user, according to some aspects of the disclosed technology. Process 1400 begins with step 1402 in which demographic data is received, e.g., by a matching model, such as matching model 1310, discussed above. As discussed above, demographic data may include virtually any information about the user, such as: age, sex, location, rental/ownership status, marital status, income level, and/or occupation, etc.

In step 1404, preference data associated with the user is received e.g., by a matching system/model of the disclosed technology. As used herein, preference data can include any data (or metadata) that can be used to directly or indirectly identify one or more personal preferences of the user. As such, preference data can include data indicating user references relating to the search and/or purchase of real estate, including user search histories, past real estate transactions, and/or preference indicators that are directly solicited from the user. For example, preference data may be generated and sent to the matching system through user engagement with a mobile application associated with a real estate searching platform. Such preference data may be provided by the user in response to one or more directed prompts, for example, requesting the user's preferences with respect to real-estate location, size, prices, layout and/or other aesthetics. Such preference data may also be further refined based on one or more offers made for a listing, offers accepted for a listing, an ultimate price of closing, and other transaction data regarding a listing.

In step 1406, listing data is received that includes listings associated with one or more parcels of real-property. By way of example, the listings may relate to offerings of land, residential real property (e.g., houses, condominiums, apartments, etc.), and/or offerings of commercial real estate (e.g., retail, office, or industrial spaces, etc.). As previously discussed, listing data may be received from one or more systems and/or databases that are part of a real estate matching system platform. Alternatively, listing data may originate with one or more remote (third-party) resources, such as a MLS database.

In some aspects, listing data may include data received from one or more on-site sensors, for example, that are configured to determine a number of people or amount of foot traffic for a given real estate listing. By way of example, sensors at the listing property location may be used to provide data that can be used to infer demand about a specific property type or more generally, about the desirability of certain property characteristics.

In step 1408, a matching relevance is determined with respect to one or more of the property listings. In some aspects, matching relevance is determined using a machine-learning (ML) matching model, as discussed above with respect to FIG. 13. By way of example, the matching model may return a single, most relevant, listing to the user. Alternatively, multiple listings may be returned in a ranking that indicates a relevance likelihood, for example, with more relevant listings being returned first or at a higher-ranking position.

In some approaches, subsequent user actions can be used to update the matching model. For example, user engagement with one or more of the returned listings may be used to infer user interest level. In some aspects, user engagement may be determined by the number of clicks within a listing (e.g., 10-20 clicks within a listing). Such data can be used to improve the ranking model, as well as to increase the amount of data (e.g., preference data) that is provided as an input for the respective user to the matching system.

Additionally, as discussed above, relevant results may also be provided to one or more parties that are associated with the user. For example, the most relevant listings can be provided to an agent or other representative that is facilitating the user's acquisition or sale of one or more parcels of real property.

Some advantages of disclosed embodiments include searches for listings that may be stored and refined after a search, based on updates or detected changes in one or more of the demographic data, preference data, listing data and/or third-party data. That is, results for one or more legacy user queries may be updated based on detected changes to real-property availability (listing data), changes to the user's disposition (demographic data), and/or detected changes to the user's interests or preferences (preference data). As discussed above, detected changes to any data inputs to the matching model may identified through data received by one or more third-parties, i.e., third-party data, or based on signals received directly from the user.

By way of example, a user may search for a house and include education as one of the preferences. This search may reveal a number of listings based on current education data. However, the education data may be updated after the search. Such a search may be saved and the listings that were previously populated for the search may change based on the updated education data. In this way, otherwise ‘dead’ past searches may be updated and provide real-time information to improve a home-buyers experience with buying a home, providing more relevant matches to that user and reducing search time.

For clarity of explanation, in some instances the present technology may be presented as including individual functional blocks including functional blocks comprising devices, device components, steps or routines in a method embodied in software, or combinations of hardware and software.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, in some cases, instructions and data which cause or otherwise configure a general-purpose computer, special purpose computer, or special purpose processing device to perform a certain function or group of functions. Portions of computer resources used can be accessible over a network. The computer executable instructions may be, in some cases, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was technology to explain aspects within the scope of the disclosed technology, no limitation of the technology should be implied based on particular features or arrangements in such examples, as one of ordinary skill would be able to use these examples to derive a wide variety of implementations. Further and although some subject matter may have been described in language specific to examples of structural features and/or method steps, it is to be understood that the disclosed subject matter is not necessarily limited to these described features or acts. In some cases, such functionality can be distributed differently or performed in components other than those identified herein. Rather, the described features and steps are disclosed as examples of components of systems and methods within the scope of the disclosure.

What is claimed is:

1. A real-property matching system, comprising:
one or more processors; and
a computer-readable medium comprising instructions stored therein, which when executed by the processors, cause the processors to perform operations comprising:
receiving, at a real-property matching model, demographic data associated with a user;
receiving, at the real property matching model, preference data associated with the user;
receiving, at the real property matching model, listing data comprising property listings associated with one or more parcels of real property; and
determining, by the real property matching model, a matching relevance for one or more of the property listings based on the demographic data associated with the user.

2. The real-property matching system of claim 1, wherein the processors are further configured to perform operations comprising:
selecting a most relevant property listing from among the one or more property listings; and
providing the most relevant property listing to the user.

3. The real-property matching system of claim 1, wherein the processors are further configured to perform operations comprising:
selecting a most relevant property listing from among the one or more property listings; and
providing the most relevant property listing to a real estate representative of the user.

4. The real-property matching system of claim 1, wherein the processors are further configured to perform operations comprising:
receiving, from the user, a selection of at least one of the property listings; and
updating the real property matching model based on the selection.

5. The real-property matching system of claim 1, wherein determining the matching relevance for the one or more property listings is further based on the preference data associated with the user.

6. The real-property matching system of claim 1, wherein the demographic data comprises information regarding one or more of: an age of the user, a location of the user, or an income of the user.

7. The real-property matching system of claim 1, wherein the preference data includes data indicating one or more of: a geographic region, a property price, a property size.

8. A computer-implemented method for matching property listings, the method comprising:
receiving, at a real-property matching model, demographic data associated with a user;
receiving, at the real property matching model, preference data associated with the user;
receiving, at the real property matching model, listing data comprising property listings associated with one or more parcels of real property; and
determining, by the real property matching model, a matching relevance for one or more of the property listings based on the demographic data associated with the user.

9. The computer-implemented method of claim 8, further comprising:
selecting a most relevant property listing from among the one or more property listings; and
providing the most relevant property listing to the user.

10. The computer-implemented method of claim 8, further comprising:
selecting a most relevant property listing from among the one or more property listings; and
providing the most relevant property listing to a real estate representative of the user.

11. The computer-implemented method of claim 8, further comprising:
receiving, from the user, a selection of at least one of the property listings; and
updating the real property matching model based on the selection.

12. The computer-implemented method of claim 8, wherein determining the matching relevance for the one or more property listings is further based on the preference data associated with the user.

13. The computer-implemented method of claim 8, wherein the demographic data comprises information regarding one or more of: an age of the user, a location of the user, or an income of the user.

14. The computer-implemented method of claim 8, wherein the preference data includes data indicating one or more of: a geographic region, a property price, a property size.

15. A non-transitory computer-readable storage medium comprising instructions stored therein, which when executed by one or more processors, cause the processors to perform operations comprising:
receiving, at a real-property matching model, demographic data associated with a user;
receiving, at the real property matching model, preference data associated with the user;
receiving, at the real property matching model, listing data comprising property listings associated with one or more parcels of real property; and
determining, by the real property matching model, a matching relevance for one or more of the property listings based on the demographic data associated with the user.

16. The non-transitory computer-readable storage medium of claim 15, wherein the processors are further configured to perform operations comprising:
selecting a most relevant property listing from among the one or more property listings; and
providing the most relevant property listing to the user.

17. The non-transitory computer-readable storage medium of claim 15, wherein the processors are further configured to perform operations comprising:
selecting a most relevant property listing from among the one or more property listings; and
providing the most relevant property listing to a real estate representative of the user.

18. The non-transitory computer-readable storage medium of claim 15, wherein the processors are further configured to perform operations comprising:
receiving, from the user, a selection of at least one of the property listings; and
updating the real property matching model based on the selection.

19. The non-transitory computer-readable storage medium of claim 15, wherein determining the matching relevance for the one or more property listings is further based on the preference data associated with the user.

20. The non-transitory computer-readable storage medium of claim 15, wherein the demographic data comprises information regarding one or more of: an age of the user, a location of the user, or an income of the user.
